(19) United States
(12) Patent Application Publication
(10) Pub. No.: US 2022/0258644 A1
(43) Pub. Date: Aug. 18, 2022

(54) Methods and Apparatus for Transport and Transmission of Data to and from a Remote Location

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/722,548

(22) Filed: Apr. 18, 2022

Related U.S. Application Data
(60) Provisional application No. 63/178,495, filed on Apr. 22, 2021.
(60) Provisional application No. 63/180,684, filed on Apr. 28, 2021.
(60) Provisional application No. 63/182,870, filed on May 1, 2021.

(51) Int. Cl. B60L 53/68; B60L 53/67; G01C 21/36

(52) U.S. Cl. CPC B60L 53/68; G01C 21/3617; B60L 53/67

(57) ABSTRACT

A charging station for electric vehicles may be positioned in a remote location where it cannot communicate with the server that supports it. Data may be transferred between the charging station and the server by physically transporting data between the remote location and a location (e.g., first location) that provides access to a network that can communicate with the server. Vehicles, electric or conventional, may be used to physically transport the data between the remote location and the first location. The vehicles may wirelessly receive data from the server or the charging station, physically transport the data to the remote location or the first location respectively, then wirelessly transmit the data to the charging station or the server respectively. The server may use methods based on past travel or future travel to select a vehicle for physical transport of data.

### FIELD OF THE INVENTION

Embodiments of the present disclosure relate to electric vehicles, charging stations and electric machines.

### BACKGROUND

As electric vehicles and other machines become more prevalent, there will need to be more charging stations to support the electric vehicles and machines. Some charging stations, just as gas stations today, will need to be in remote locations. Further, some electric vehicles and machines will operate in remote locations for extended periods for time. Many remote locations may have access to electricity, but not have access to a communication network and in particular a long-range communication network (e.g., long-range network). Lacking a communication network, receiving data from and/or sending data to the charging stations, vehicles and machines positioned at a remote location may be difficult if not impossible. Owners of charging stations, vehicles and machines in remote locations may benefit for transferring data to and from charging stations, electric vehicles and/or electric machines positioned in remote locations.

### BRIEF DESCRIPTION OF THE DRAWING

Embodiments of the present invention will be described with reference to the drawing, wherein like designations denote like elements, and:

FIG. 1 is a diagram of electric vehicles, charging stations and electric machines positioned at various locations including remote locations;

FIG. 2 is a diagram of a mobile vehicle at a location that provides access to a long-network;

FIG. 3 is a diagram of data transfer between a charging station and a mobile vehicle at a remote location;

FIG. 4 is a diagram of data transfer between a charging station, an electric machine and/or a mobile vehicle at a remote location;

FIG. 5 is a diagram of an example embodiment of data stored by a server;

FIG. 6 is a diagram of an example embodiment of segmented data;

FIG. 7 is a flowchart of an example method for a server to transfer data to a mobile vehicle for physical transport and subsequent transmission to remote equipment;

FIG. 8 is a flowchart of an example method for subsequent transmission of data by a mobile vehicle to remote equipment after physical transport of the data;

FIG. 9 is a flowchart of an example method for remote equipment to transfer data to a server by physical transport and subsequent transmission by a mobile vehicle;

FIG. 10 is a flowchart of a first example method for identifying a mobile vehicle to perform physical transport and subsequent transmission of data to remote equipment;

FIG. 11 is a flowchart of a second example method for identifying a mobile vehicle to perform physical transport and subsequent transmission of data to remote equipment;

FIG. 12 is a diagram of an example embodiment of financial transaction data stored by a charging station for transfer to a server;

FIG. 13 is a diagram of an example embodiment of health data and self-test results stored by a charging station for transfer to a server;

FIG. 14 is a diagram of an example embodiment of health data and self-test results stored by an electric machine for transfer to a server;

FIG. 15 is a flowchart of a first example method for transferring data from remote equipment to a server;

FIG. 16 is a flowchart of a second example method for transferring data from remote equipment to a server.

FIG. 17 is a block diagram of an example embodiment of a computer for a charging station;

FIG. 18 is a block diagram of an example embodiment of a computer for a mobile or electric vehicle; and

FIG. 19 is a block diagram of an example embodiment of a computer for an electric machine.

### DETAILED DESCRIPTION

### Overview

Machines (e.g., 132, 152) includes tractors, agricultural equipment, construction equipment, excavation equipment, or other similar equipment. Machines may be powered by electricity (e.g., electric machine) and include a battery for providing the electrical power. Machines may be referred to as machines, electric machines or equipment. Electric vehicles (e.g., 134), charging stations (e.g., 120-126) and/or machines (e.g., 132, 152) that are positioned at a remote location, beyond the reach of long-range network 220, may be collectively or individually referred as remote equipment.

Electric vehicles (e.g., 134, 170-180), charging stations (e.g., 120-126) and machines (e.g., 132, 152) tend to include advanced technology and, generally, are “connected” devices. The term “connected” means that the electric vehicles, charging stations and machines are able to communicate with each other and/or with other electronic devices. Further, an electric vehicle, charging station or machine that has access to a long-range network is able to communicate with servers that are physically distant from the vehicle, charging station or machine.

Electric vehicles, or even connected conventional vehicles, (e.g., 170-180) not situated at a remote location, referred to herein as mobile vehicles, may be used to physically transport (e.g., ferry, carry, haul, transfer) and transmit data between (e.g., to, from) the server 112 and remote equipment (e.g., 120-126, 132, 134, 152) to enable communicate between the server 112 in the remote equipment.

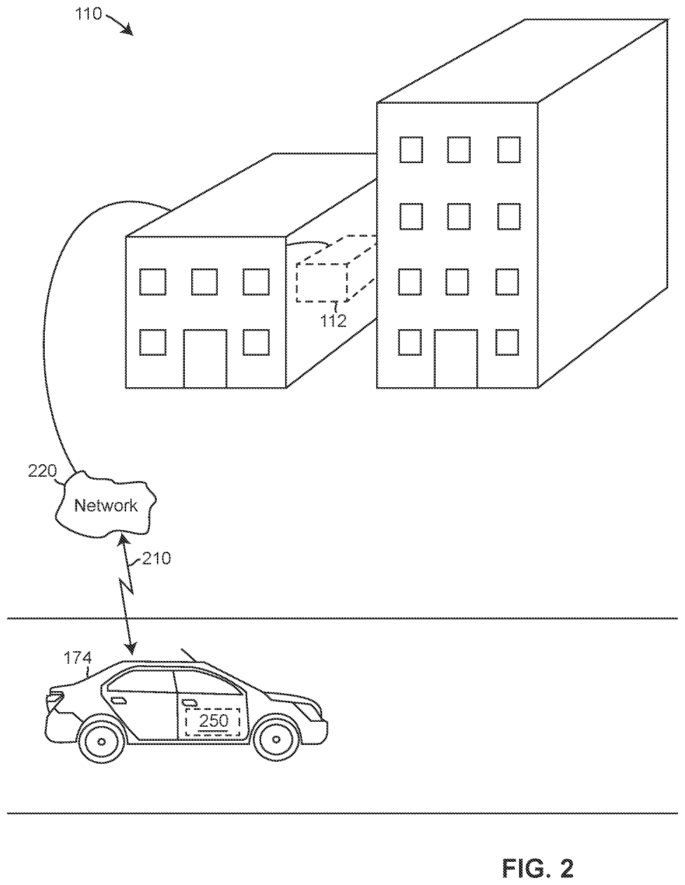

For example, referring to FIG. 2, while the mobile vehicle 174 is positioned in city 100, the mobile vehicle 174 has access to the long-range network 220 via the short-range wireless link 210 and can communicate with the server 112. In this example, the server 112 has data for a charging station 126, but cannot transmit the data to the charging station 126 because the charging station 126 does not have access to a long-range network. However, the data may be physically transported and subsequently transmitted to the charging station 126 via the mobile vehicle 176.

The mobile vehicle 176 (e.g., computer 250) receives the data intended for the charging station 126 via the long-range network 220 and a short-range wireless link 210. The mobile vehicle 176 stores the data in the memory 1830 of the computer 250. The computer 250 is connected to the mobile vehicle 176, so the computer 250 travels with the mobile vehicle 176 as it travels (e.g., drives around). When the mobile vehicle 176 stops at or drives past the charging station 126, the mobile vehicle 176 transmit the data from its computer 250 to the charging station 126 (e.g., computer 330 thereof) via a short-range wireless communication link (e.g., 310, 410).

In another example, while a mobile vehicle 178 is being charged at the charging station 122 or while a mobile vehicle 180 is driving past machine 132, the charging station 122 and/or the machine 132 may provide data to the mobile vehicle 178 or 180 respectively that is intended for the server 112. The mobile vehicles 178 and 180 store the data in the memory of their respective computers 250. When the mobile vehicles 178 and 180 arrive at a location (e.g., city 110) that provides access to a long-range communication network (e.g., 220), the mobile vehicle 178 and 180 communicate with the long-range network using wireless short-range communication links (e.g., 310, 414). The computers 250 transmits their respective data to the server 112 via the long-range network.

As illustrated in the above examples, communication between the remote equipment (e.g., 120-126, 132, 134, 152) and the server 112 includes the physical transportation of data between the server 112 and the remote equipment (e.g., 120-126, 132, 134, 152) and the subsequent transmission of the data between the mobile vehicle (e.g., 170-180) and the remote equipment.

In a situation where the owners or operators of the mobile vehicles (e.g., 170-180) are not required to drive to specific remote locations (e.g., 120-126, 130, 150) or to drive along specific routes, such as highways 190-194, that go (e.g., drive) past remote equipment (e.g., 120-126, 132, 134, 152), the physical transport of data to remote equipment requires organization and may include the analysis of past driving behavior of the mobile vehicles or planned future driving of the owners of the mobile vehicles. The server 112 may provide data intended for remote equipment to many mobile vehicles in the hope that one of the mobile vehicles will drive to or by the remote location (e.g., 120-126, 130, 150) where the remote equipment that is the intended recipient of the data is located. The server 112 may use various techniques to determine the likelihood of a mobile vehicle passing through a remote location and thereby provide data for transport to those mobile vehicles with the highest likelihood of traveling to or through a remote location.

### Long-Range Communication

A long-range network or long-range communication network (e.g., 220) refers to a network capable of communicating (e.g., transmitting, receiving) data (e.g., information) over distances measured in miles or hundreds of miles. A long-range network may include, for example, a cell phone network, a metropolitan area network, a wide area network, a cloud network or any other type of long-range network, including the Internet. A long-range network generally is a combination of wired and wireless networks. A mobile vehicle (e.g., 170-180) may use a wireless communication link (e.g., 210, WiFi, cellular) to access the long-range network. The mobile vehicles may receive data from and provide data to a server (e.g., 112) via a long-range network. A mobile vehicle may communicate via a long-range network using any suitable communication protocol.

### Short-Range Communication

Remote equipment (e.g., 120-126, 132, 134, 152) may communicate via short-range wireless (e.g., broadcast) and/or a short-range wireless communication link (e.g., 310, 410, 412, 414, short-range wireless link, one-to-one). The remote equipment may communicate directly with each other via wireless short-range wireless links (e.g., 414). A short-range wireless link refers to wireless communication over distances measured in feet, for example up to 150 feet. A short-range network generally is a wireless network of limited-range. A short-range network may also be referred to as a local network. Short-range network communication protocols may include, for example, WiFi (e.g., 802.11 a/b/g/n), Bluetooth and ZigBee. Although the range for short-range communication may be limited, the throughput (e.g., bit rate) may be high. Remote equipment may communicate via a short-range wireless communication using any suitable communication protocol.

Short-range communication may include communication using near-field technologies. Near-field communication (“NFC”) includes wireless communication of up to 4 cm in range. Protocols may include the protocols developed by, inter alia, the GSM Association and the NFC Forum. Communication using a near-field protocol is a low speed. A near-field communication link may be used to bootstrap into a short-range wireless link.

### Security and Authentication

Long-range and short-range communication protocols may provide secure communication that is resistant to tampering such as man-in-the-middle attacks, eavesdropping and relay attacks. Devices (e.g., 250, 330, 450, 112) that communicate via a long-range and/or short-range networks may authenticate themselves to each other prior to communication and may encrypt communications to provide secure communication.

Although authentication and encryption are not explicitly shown in some of the figures of the present disclosure, authentication may be performed at any point during (e.g., prior) communication and encryption may be performed during the communication.

### Autonomous Transfer

The transfer of data from the server 112 to a mobile vehicle; a mobile vehicle (e.g., 170-180) to the server 112; a mobile vehicle to remote equipment (e.g., 120-126, 132, 134, 152); or remote equipment to a mobile vehicle may be accomplished autonomously, which means without human intervention. Whenever data needs to be transferred from the server 112 to remote equipment, the server 112 identifies one or more mobile vehicles for transport of the data without human intervention. The server 112 transmits the data to the identified mobile vehicles without human intervention. When the mobile vehicle transporting the data arrives at or passes by the remote location (e.g., 120-126, 130, 150) where the intended recipient is positioned, the mobile vehicle identifies the specific piece of remote equipment that is the intended recipient without human intervention. The mobile vehicle transmits the data to the specific piece of remote equipment without human intervention.

Whenever data needs to be sent from a piece of remote equipment (e.g., 120-126, 132, 134, 152) to the server 112, the piece of remote equipment identifies the mobile vehicles at or passing by the remote location (e.g., 120-126, 130, 150) without human intervention. The piece of remote equipment transmits the data to the identified mobile vehicles without human intervention. When the mobile vehicle transporting the data enters an area that provides long-range network 220, the mobile vehicle identifies and connects to the long-range network 220 without human intervention. The mobile vehicle transmits the data to the server 112 without human intervention.

The operator and/or the passengers of the mobile vehicle are not involved in the reception and/or transmission of the data by the mobile vehicle. The driver or the passengers of mobile vehicles do not need to take any action to receive data from server 112 or remote equipment (e.g., 120-126, 132, 134, 152) or to transmit data to remote equipment or the server 112. Further, the driver of the mobile vehicle need not operate the mobile vehicle with the intent of driving to or past a specific remote location (e.g., 120-126, 130, 150) or remote equipment so that the mobile vehicle can transfer the data to or receive data from the remote equipment. The driver is not required to drive to a specific location or along a specific route. The driver merely drives along routes and to destinations selected by the driver. Unbeknownst to the driver, the mobile vehicle, or the computer (e.g., 250) thereof, performs all of the actions needed to transmit data to and/or receive data from the server 112 or the remote equipment. The computer may test, from time to time, to see whether it can establish a short-range wireless link (e.g., 310, 410, 412) with nearby remote equipment or with the long-range network 220 that can be used to communicate with the server 112. When a short-range wireless link can be established with a piece of remote equipment, the mobile vehicle transfers the data to or receives data from the piece of remote equipment autonomously. When a short-range wireless link 210 can be used to establish a link with the long-range network 220, the mobile vehicle 174 transfers data to or receive data from the server 112 autonomously.

### Example Embodiment

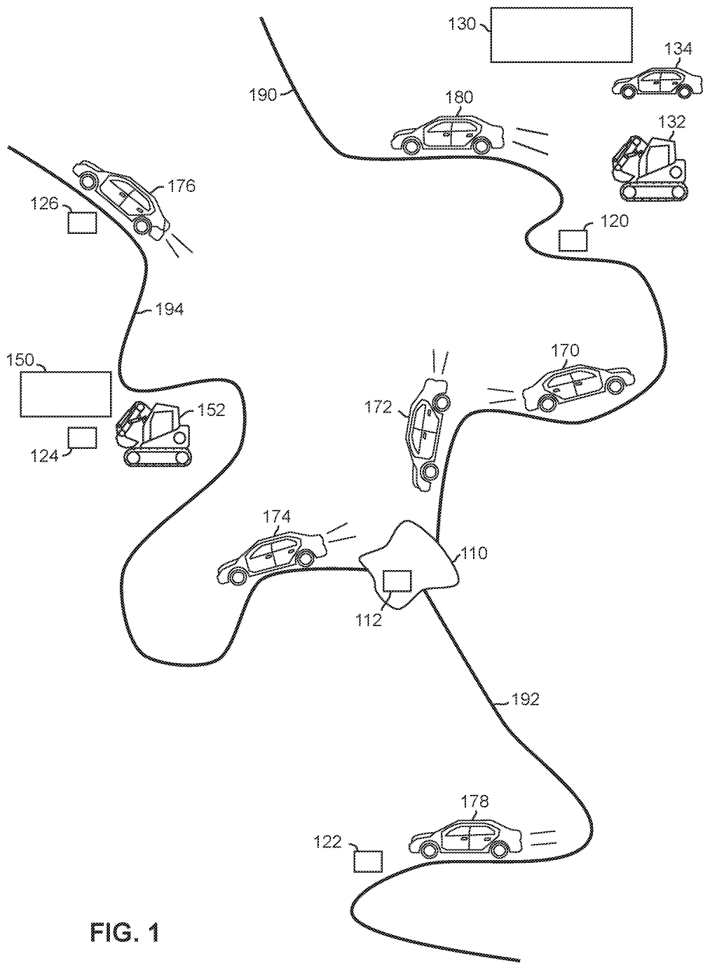

In an example embodiment, best shown in FIG. 1, charging stations 120, 126 and 122 are positioned near highway 190, highway 194 and highway 192 respectively. Charging station 124 is positioned near highway maintenance area 150 for exclusive use by the highway maintenance electric vehicles and machines such as a tractor 152. Machines are also positioned at mining operation 130 near highway 190, such as a tractor 132 and an electric vehicle 134. The charging stations 120-126 and the machines 132, 134 and 152 do not have access to long-range communication services, so the charging stations 120-126 and the machines 132, 134 and 152 cannot communicate with the server 112, that is located in the city 110.

The vehicles 170-180 are mobile vehicles. The mobile vehicles 170-180 may be any motor vehicle or type of vehicle. Any person or entity may own the mobile vehicles. The owner, agents of the owner, or employees may operate the mobile vehicles for any purpose. The mobile vehicles may have some aspect in common, such as the same manufacturer or the same service (e.g., navigation, maintenance, infotainment distributor) provider. In an example embodiment, the mobile vehicles 170-180 are privately owned vehicles whose drivers live in city 110 and drive around. It is possible that some of the vehicle owners are employed at the highway maintenance area 150 or the mining operation 130, so possibly some of the mobile vehicles travel to these remote locations frequently. The mobile vehicles 170-180 are able to communicate with the long-range network 220 while inside the limits of the city 110. While a mobile vehicle 170-180 is connected to the long-range network 220, their respective computers 250 may communicate with the server 112. The server 112 need not be physically located in the city 110, but may be located anywhere and accessed via the long-range network 220 that is assessable in the city 110.

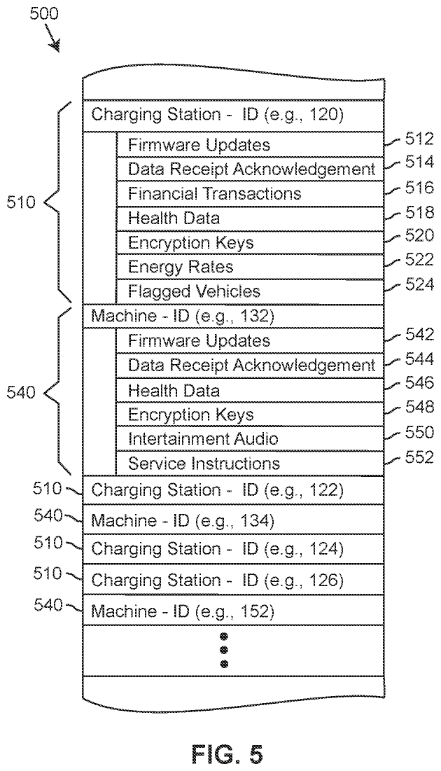

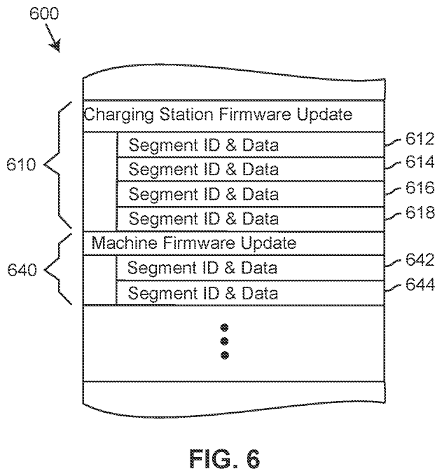

In an example embodiment, the server 112 stores the data shown in data structure 500 in FIG. 5. The server 112 stores data for sending to the remote charging stations (e.g., 120-126) and data for sending to the remote machines (e.g., 132, 134, 152). The server 112 also stores data received from the remote equipment 120-126, 132, 134, 152, such as financial transactions 216 and health data 518 and 546. The type of data stored in the data structure 500 is not limiting. There may be other types of data intended for transfer to remote equipment. Further, the remote equipment may have other types of data that is sent to the server 112 that is stored in the data structure 500.

In an example embodiment, server 112 provides other services (e.g., navigation, infotainment services, maintenance notices, route planning services, vehicle operational data, charging station information) to the mobile vehicles 170-180, so server 112 maintains other data related to the mobile vehicles 170-180. In the event that the server 112 provides navigation services, including route planning services to a mobile vehicle, the server 112 may maintain a record of past trips taken by the mobile vehicle and may even have data regarding future planned trips of the mobile vehicle. Such data may be used by the server 112 to determine the likelihood of whether a mobile vehicle will travel within range of remote equipment for delivering and/or receiving data.

The mobile vehicles 170-180 that drive along highway 190 drive within short-range wireless range of the charging station 120 and the remote equipment (e.g., 132, 134) at mining operation 130. The mobile vehicles 170-180 that drive along highway 192 drive within short-range wireless range of the charging station 122. The mobile vehicles that drive along highway 194 drive by the remote equipment at the highway maintenance area 150 and the charging stations 124 and 126. Although FIG. 1 shows the mobile vehicles 170 and 180 on highway 192, the mobile vehicles 170 and 172 on highway 190 and the mobile vehicles 174 and 176 on highway 194, any of the mobile vehicles 170-180 may travel along any highway at any time.

In this example, the scenarios in which communication occurs are shown in FIGS. 2-4. In FIG. 2, the mobile vehicle 174 is positioned inside the city 110. While inside the city 110, the computer 250 of the mobile vehicle 174 communicate via a short-range wireless link 210 with the long-range network 220. Once connected to the long-range network 220, the computer 250 may communicate with the server 112. While connected to the server 112, the computer 250 may receive data from the server 112 for transfer to remote equipment and/or provide data to the server 112 from remote equipment. The mobile vehicle 174 does not need to be stationary to establish the short-range wireless link 210 with the long-range network 220. Ideally, the computer 250 of the mobile vehicle 174 may communicate with the server 112 via the long-range network 220 while the mobile vehicle 174 is moving around within the city 110.

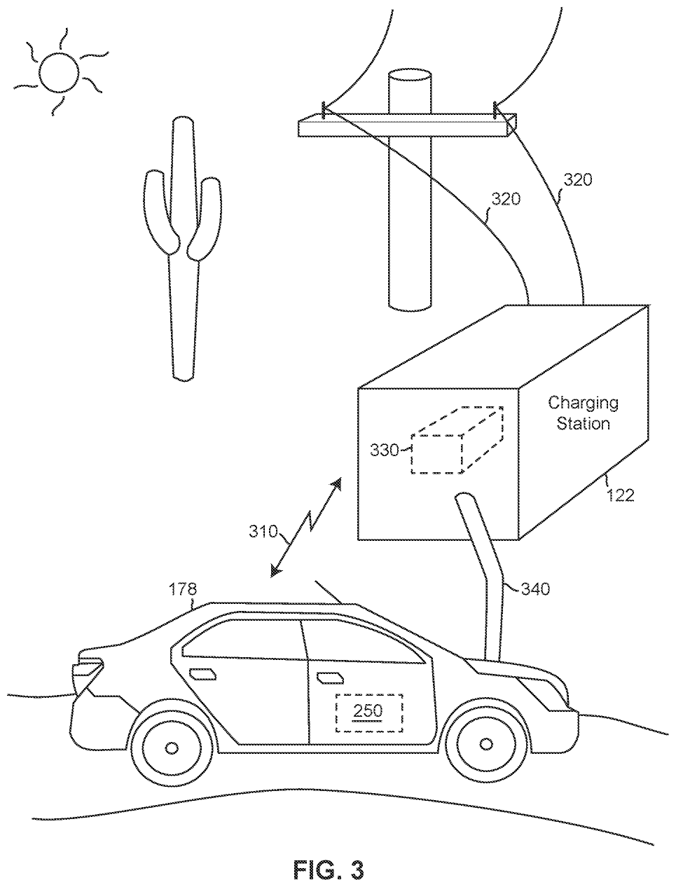

In the example shown in FIG. 3, the mobile vehicle 178 is recharging its battery using services from the charging station 122. Although the charging station 122 has access to electrical power via electrical lines 320, the charging station 122 does not have access to a long-range network, so the charging station 122 cannot communicate with the server 112. Further, while the mobile vehicle 178 is positioned at the remote location where charging station 122 is located, the mobile vehicle 178 cannot communicate with the server 112 either. While the mobile vehicle 178 is receiving charge from the charging station 122 via the cable 340, the computer 250 of the mobile vehicle 178 communicates with the computer 330 of the charging station via short-range wireless link 310. The computer 250 may provide data to the computer 330 that is been transported from the server 112 to the charging station 122 and/or receive data from the charging station 122 for transport to the city 110 where the data may be transmitted to the server 112.

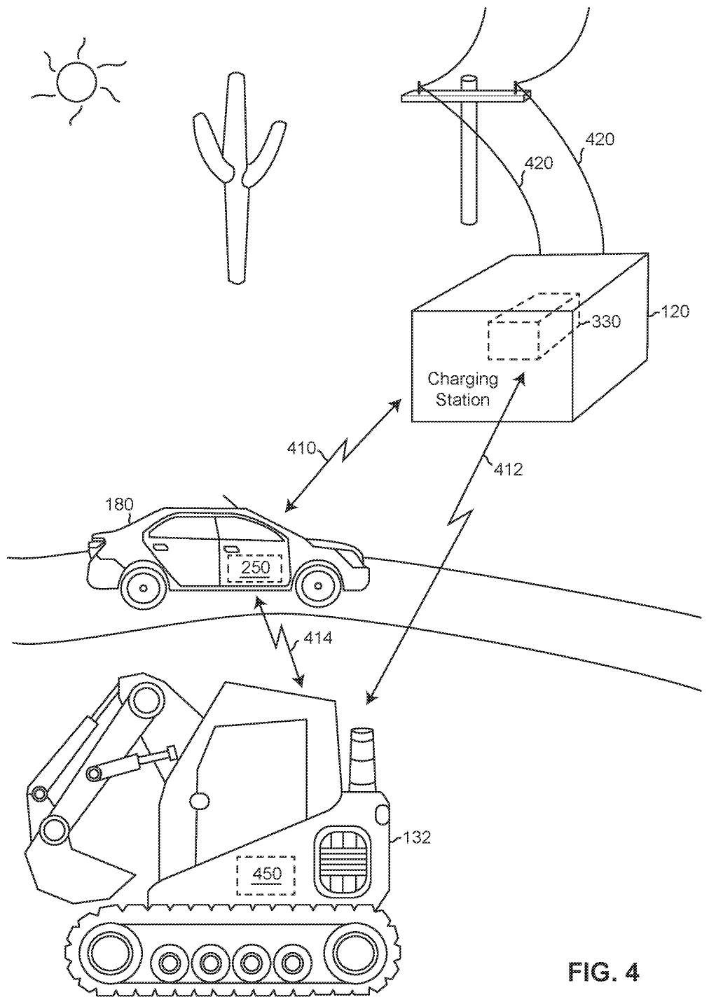

In the example shown in FIG. 4, the mobile vehicle 180 is passing by the charging station 120 and machine 132. Although the charging station 120 has access to electrical power via powerlines 420, neither the charging station 120 nor the machine 132 can communicate with the server 112. While the mobile vehicle 180 is proximate to the charging station 120 and the machine 132, computer 250 of the mobile vehicle 180 establishes the short-range wireless link 410 with the computer 330 of the charging station 120 and/or the short-range wireless link 414 with a computer 450 of the machine 132. The computer 250 may provide data to the computer 330 and/or the computer 450 that has been physically transported by the mobile vehicle 180 and is originally from the server 112. The computer 330 and/or the computer 450 may provide data to the computer 250 for transport and subsequent transmission to the server 112.

Communication between the computers 250, 330 and 450 may continue as long as the mobile vehicle 180 is in wireless range of the charging station 122 and/or the machine 132. Since the time it takes for the mobile vehicle 170-180 to drive by the remote equipment 120-126, 132, 134, 152 may be brief, the time for communication between the computer 250 of the mobile vehicle and the computer (e.g., 330, 450) of the remote equipment may also be brief. So, as discussed below data that is transmitted between the mobile vehicles and the remote equipment may be segmented so that the data is transmitted in small chunks to increase the likelihood of transmitting or receiving at least some data. A scheme may be used to track which segments have been received, so that received segments do not need to be retransmitted, but subsequent transmissions may continue with the last segment received.

In another example embodiment, one piece of remote equipment may relay data from another piece of remote equipment to a mobile vehicle. For example, referring to FIG. 4, assume that the machine 132 can wirelessly communicate with the charging station 120, but cannot wirelessly communicate (e.g., interference, distance) with the mobile vehicle 180. If the machine 130 has data that it wants to send to the server 112, the computer 450 of the machine 132 may transmit the data intended for the server 112 to the computer 330 of the charging station 120 and the computer 330 may transmit the data to the computer 250 the mobile vehicle 180. Any piece of remote equipment may serve as a relay for one or more other pieces of remote equipment. Data may be sent via relay to the server 112 are received by relay from the server 112.

### Data Stored by the Server Related to Charging Stations

In an example embodiment, the server 112 stores data for transmission to the remote equipment (e.g., 120-126, 132, 134, 152) and data received from the remote equipment. The server 112 stores the data in a database. In an example embodiment, the server 112 stores the data in the data structure 500. The data structure 500 includes one or more records of data 510 for data related to charging stations and/or one or more records of data 540 for data related to machines.

The server 112 may store multiple instances of the data 510. Each instance of the data 510 is for a specific charging station (e.g., 122, 124, 126). Each charging station may be identified by an identifier. The server 112 may use any technique for distinguishing between the various instances of the data 510 and the identity of the charging station to which each instance of the data 510 relates. In an example embodiment, each charging station includes a respective identifier (e.g., ID 1734) so the various charging stations may be distinguished from each other. The data 510 may include the identifier of the charging station.

The data 510 includes data for transfer to a charging station and data received from a charging station. Each data 510 is for a specific charging station 122, 124 or 126. The data 510 stores data that should be sent to (e.g., intended for) a specific charging station. The data 510 stores data that was received from the specific charging station. In an example embodiment, the data 510 shown in FIG. 5 relates to charging station 120. The data 510 includes firmware updates 512, data receipt acknowledgments 514, encryption keys 520, energy rates 522, flagged vehicles 524, and advertising 526, which is data for sending to the charging station 120. The data 510 further includes financial transactions 516 and health data 518, which is data received from the charging station 120. As discussed above, data that is sent to and received from the charging station 120 includes physically transportation by the mobile vehicle 170-180. Each charging station 120, 122, 124 and 126 has a respective data 510.

Continuing the example related to charging station 120, the firmware updates 512 store firmware updates for the charging station 120. Firmware update 512 may further store a complete version of the current firmware used by charging station 120. Updates, or changes, to the firmware of charging station 120 are stored in firmware updates 512 for sending to the charging station 120. As discussed earlier, firmware, or other data, may be segmented for transmission by the mobile vehicle 170-180 to the charging station 120.

Encryption keys 520 stores encryption keys and/or other data related to security and/or authentication. The encryption keys 520 may be sent to charging station 120 to authenticate the mobile vehicles 170-180 and machines 132, 134 and 152. The encryption keys 520 sent to charging station 120 may be stored in the computer 330 of the charging station 120. The data may be stored in memory 1730 as authentication data 1732.

Energy rates 522 stores data related to the cost of delivery of energy by the charging station 120 to any electric vehicle or machine (e.g., 132, 134, 152). Energy rates 522 may be used to inform an operator of an electric vehicle or machine the cost of recharging at the charging station 120. Energy rates 522 may also include data related to the cost of providing charging services or any other financial information needed to provide charging services. The energy rates 522 data may be stored by the computer 330 of the charging station 120 in the memory 1730 as data 1736.

Flagged vehicles 524 stores data related to electric vehicles or machines that have been flagged for some reason. An electric vehicle or machine may be flagged for not responding to a recall notice, a notice for upgrades, a notice for repairs and/or for a financial account that is in arrears. The charging station 120 may use the information provided in flagged vehicles 524 to inform the driver of the vehicle or machine of the notices. The charging station 120 may use data provided in flagged vehicles 524 to refuse service to an electric vehicle or machine. The flagged vehicles 524 data may be stored by the computer 330 of the charging station 120 in memory 1730 as data 1736.

Advertising 526 stores advertising data. Advertising 526 includes audio, graphical and/or video data that is displayed on the screen of the charging station 120 while an electric vehicle or machine is being charged. The advertising 526 data may be stored by the computer 330 of the charging station 120 in memory 1730 as data 1736.

Each time the server 112 receives data from the charging station 120, the server 112 generates an acknowledgment acknowledging the receipt of the data from the charging station 120. The acknowledgment needs to be sent to the charging station 120, so that the charging station 120 knows that the data it sent to the server 112 was received. The server 112 generates and stores the acknowledgments in data receipt acknowledgment 514 until they can be transmitted to the charging station 120. The acknowledgments may be deleted from data receipt acknowledgment 514 after a period of time that is sufficient for delivery to the charging station 120 or a scheme may be used that includes a second acknowledgment from the charging station 120 that verifies receipt of the acknowledgment from the server 112.

The server 112 may receive data from the charging stations. Data received from a charging station may include financial transactions and health data. Data regarding financial transactions may be stored in financial transactions of 516 of the data 510 associated with the charging station that sent the data. Data regarding the health of the charging station may be stored in health data 518 of the data 510 associated with the charging station that sent the data. Data for multiple financial transactions or multiple reports on the health of the charging station may be stored in financial transactions 516 and health data 518 respectively.

### Charging Station Financial Transaction Data

When an electric vehicle or machine pulls into a remote charging station (e.g., 120-126), it may communicate directly with the charging station using short-range or limited-range wireless communication. Via wireless communication, the vehicle in the charging station may provide and/or receive:
credentials (e.g., vehicle ID, charging station ID, machine ID one-time passwords) for authenticate;
data related to charging the battery (e.g., battery status prior to charging, battery status after charging, energy provided, temperature of battery, atmospheric temperature, consumption data, estimated duration of recharge, actual duration of recharge, cost of recharge) of the vehicle;
other data (e.g., time, date, temperature, geographic location, altitude, vehicle travel information, route information to other charging stations); and
data for completing the financial portion (e.g., driver identification, credit card number, account number, transaction verification information) related to charging the vehicle or machine.

Once the battery of the electric vehicle or machine has been recharged, the charging station may provide information to a financial institution so the owner of the charging station may receive payment for the energy provided to the electric vehicle or machine. Remote charging stations 120-126 do not have access to a long-range network, so the charging station cannot provide information to the relevant server for payment for the services provided. So, the charging station sends the financial information to the relevant server via the mobile vehicle 170-180.

In an example embodiment, shown in FIG. 3, mobile vehicle 178 is being charged by charging station 122 via cable 340. The computer 250 of the mobile vehicle 170 communicates with the computer 330 of the charging station 122 via the short-range wireless link 310. The mobile vehicle 178 may authenticate the charging station 122, and/or vice versa, prior to charging. When charging is complete, the computer 330 of the charging station 122 provides financial transaction data to the computer 250 of the mobile vehicle 178 for physical transport and subsequent transmission (e.g., transfer) to the server 112.

In an example embodiment, the data related to a financial transaction is stored in financial transaction (e.g., data structure, record) 1200. Financial transaction 1200 may include data such as, inter alia: vehicle ID 1210, vehicle authentication data 1212, consumption data 1214, battery status prior to charging 1216, battery status after charging 1218, energy received 1220, charging station ID 1230, photograph of vehicle 1234, time and date 1236, geographic location 1238, altitude 1240, and destination server 1242. A respective financial transaction 1200 record is created for each charging service provided.

The vehicle ID 1210 is the identifier for the mobile vehicle 178 which the computer 330 receives via the short-range wireless link 310. The vehicle authentication data 1212 may include data used during authentication or evidence of a successful authentication. Consumption data 1214 identifies the amount of electrical power consumed to provide recharging services to the mobile vehicle 178. Battery status prior to charging 1216 provides information regarding the status of the battery in the mobile vehicle 178 prior to charging. Battery status after charging 1218 provides information regarding the status of battery in the mobile vehicle 178 after charging. The information regarding the status of the battery may be provided by the computer 250 to the computer 330 via the short-range wireless link 310. Energy received 1220 provides information regarding the amount of energy delivered to the battery of the mobile vehicle 178. Energy received 1220 is the amount of energy for which financial charges should be made. Charging station ID 1230 is the identifier of the charging station 122. The charging station ID 1230 identifies the charging station that provided the charging services and the charging station to which financial payment is due. Charging station ID 1230 is the same as the ID 1734 stored in the memory 1730 of the computer 330 of the charging station 122. Photograph of vehicle 1234 is a photograph of the mobile vehicle 178 taken by the charging station 122 while providing charging services. The photograph provides evidence that charging services were actually provided. Time and date 1236 are the time and date the services were provided. Geographic location 1238 is the geographic location of the charging station 122. The geographic location 1238 is a same as the geographic location 1738 stored in the memory 1730 of the computer 330 of the charging station 122. Altitude 1240 is the altitude at which the charging station 122 is located.

Each time the charging station 122 provides charging services, the computer 330 creates financial transaction 1200, so charging station 122 may send many financial transaction 1200 records to the server 112.

The computer 330 of the charging station 122 transmits the financial transaction 1200 to the computer 250 of mobile vehicle 178. If for some reason the computer 250 cannot receive the financial transaction 1200, the charging station 122 may transmit financial transaction 1200 to another mobile vehicle for transfer to the server 112. The computer 250 stores the financial transaction 1200. As the mobile vehicle 178 travels, it physically transports the financial transaction 1200 in the computer 250. When the mobile vehicle 170 arrives at an area (e.g., city 100) that provides access to a long-range network (e.g., 220), the computer 250 transmits the financial transaction 1200 to the server 112. When the server 112 receives the financial transaction 1200, the server may store the financial transaction 1200 in financial transactions 516. Financial transactions 516 may include many financial transactions 1200 from the charging station 122. The server 112 processes the financial transaction so that the owner of the charging station 122 receives payment. Upon receipt of the financial transaction 1200, the server 112 generates an acknowledgment.

### Charging Station Health Data

A charging station (e.g., 120-126) is a sophisticated machine that can monitor and test its own operation. Data that results from monitoring and testing may be stored in a data structure and sent to a server for storing and monitoring the health of the charging station. In an example embodiment, charging station 122 monitors its own operation and performs self-tests. Charging station 122 stores the data collected from monitoring and testing in a data structure referred to as health 1300. In an example embodiment, the charging station health 1300 includes data related to:

health packet identifier 1310;

charging service history 1312;

incoming electrical characteristics 1318;

outgoing electrical characteristics 636;

temperature 1340; and

self-test results 1346.

Health packet identifier 1310 includes an identifier that allows the server 112 to identify the charging station 122. Health packet identifier 1310 may further include the date and time of creation of the health 1300 record. Charging station 122 may create many health 1300 records related to monitoring and tests performed at different times. Each health 1300 record may be transferred to the server 112.

The charging service history 1312 includes one or more records (e.g., 1314, 1316) identifying the charging services provided by the charging station 122. Each record (e.g., 1314, 1316) provides the vehicle ID of the electric vehicle or machine that received the charging services. Each record (e.g., 1314, 1316) may include other information such as time, date, duration, charging profile, temperature profile and spikes. Each record (e.g., 1314, 1316) may include all or a portion of the data found in financial transaction 1200. Records (e.g., 1314, 1316) of the charging service history 1312 may be eliminated for specific vehicles once the charging station 122 has received acknowledgment from the server 112 that the record for that vehicle has been received.

The incoming electrical characteristics 1318 stores data regarding the characteristics of electricity being provided to the charging station 122. Incoming electrical characteristics 1318 may include, inter alia, noise, spikes, etc. 1320, RMS voltage 1322, RMS current 1324, under-voltage 1326, under-current 1328, frequency variations 1330, harmonics 1332, and line impedance 1334.

The outgoing electrical characteristics 1336 stores data regarding the characteristics of electricity provided by the charging station 122 to the electric vehicle and machines. The outgoing electrical characteristics may include all or some of the characteristics monitored for the incoming electricity (e.g., 1320-1334).

The temperature 1340 provides information regarding the temperature of the cable 340 (e.g., 3042) and the atmospheric temperature (e.g., 1344).

The self-test results 3046 stores data regarding the results of self-tests performed by the charging station 122. The self-tests test various equipment and functions of the charging station 122 And stores the results of the self-test. Testing the display (e.g., monitor, screen) of the charging station 122 provides the data for display 1348. Testing the power supply provides data for power supply 1350. Testing the pump that circulates the cooling/heating medium used to heat or cool the component of the charging station 122 provides the data for cooling/heating medium pump 1352. Testing the locking mechanism that retains the nozzle of the cable 340 when inserted into the housing of the charging station 122 provides the data for locking mechanism 1354. Testing the currents provided by the recharging equipment of the charging station 122 provides data for current tests 1356. Tests that control the heating or cooling of the component of the charging station 122 provide the data for temperature tests 1358.

The computer 330 of the charging station 122 monitors the operation of the charging station 122, the characteristics of the incoming electricity, the characteristics of the outgoing electricity and the temperature. The computer 330 the charging station 122 controls and administers the self-tests used to test the operation of the charging station 122. The computer 330 stores the results of each self-test performed. The computer 330 also collects data regarding the vehicles that are charged by the charging station 122. The computer 330 creates the health 1300 record and populates it with data.

Since the charging station 122 is a remote charging station, many health 1300 records may be created prior to arrival of a mobile vehicle that can transport the data to the server 112. So, the computer 330 of the charging station 122 may create and store multiple health 1300 records that are sent to the server 112 when possible. A health 1300 record may be removed from the memory 1730 of the computer 330 once the computer 330 receives acknowledgment that the server 112 has received the record.

When the opportunity arises, the charging station 122 transfers the health 1300 records to a mobile vehicle 170-180 for physical transport and subsequent transmission to the server 112.

### Data Stored by the Server Related to Machines

As discussed above, as best shown in FIG. 5, the server 112 stores data for transmission to machines (e.g., 132, 134, 152) in a data structure 540 that is part of the data structure 500.

The server 112 may store multiple instances of the data 540. Each instance of the data 540 is for a specific electric machine (e.g., 132, 134, 152). The server 112 may use any technique for distinguishing between the various instances of the data 540 and the identity of the specific electric machine to which each instance of the data 540 relates. In an example embodiment, each electric machine includes a respective identifier (e.g., ID 1934) so the various machines may be distinguished from other machines. The identifiers for the charging stations and for the machines may also be used to distinguish machines from charging stations.

The data 540 includes data for sending to remote machines and data received from remote machines. Each data 540 is for a specific machine 132, 134 or 152, so the data that should be sent is sent to that specific machine. The data 540 that is received data was received from that specific machine. For example, the data 540 that relates to the machine 132 includes firmware updates 542, data receipt acknowledgments 544, encryption keys 548, audio entertainment 550, and service instructions 552, which is data that is sent to machine 132. The data 540 that relates to remote equipment 132 further includes health data 546, which is data received from the machine 132. Each remote equipment 132, 134 and 152 has a respective data 510.

In an example embodiment, the firmware updates 542 stores firmware updates for the machine 132. Firmware updates 542 may store a complete version of the current firmware used by machine 132. Updates, or changes, to the firmware of the machine 132 are stored for sending to the machine 132. As discussed earlier, firmware, or other data may be segmented for transmission by the mobile vehicle 170-180 to the machine 132.

Encryption keys 548 stores encryption keys and/or other data related to security and/or authentication. The encryption keys 548 may be sent to machine 132 to authenticate the mobile vehicles 170-180 and remote machine 132, 134 and 152. The encryption keys 548 sent to machine 132 may be stored in the computer 450 of the machine 132. The data may be stored in a memory 1930 as authentication data 1932.

Audio entertainment 550 stores audio files that may be listen to while operating machine 132. The computer 450 of the machine 132 may store the audio files in data 1936 in the memory 1930. The computer 450 may provide the audio files to the infotainment system of the machine 132.

Service instructions 552 stores data regarding the maintenance of the machine 132. The service instructions 552 may include service bulletins and/or instructions on how to perform service. The service instructions 552 may store video files, audio files, images, and/or text that relates to performing service on the machine 132. The computer 450 may present the information from the service instructions 552 on a display for viewing by the person performing the maintenance.

Each time the machine 132 receives data from the server 112, the machine 132 generates an acknowledgment acknowledging the receipt of the data from the server 112. The acknowledgment needs to be sent to the server 112, so that the server 112 knows that the data it sent to the machine 132 was received. The machine 132 generates and stores the acknowledgments in data receipt acknowledgment 1938 in the memory 1930 of the computer 450. When the opportunity arises, the machine 132 transmits the data receipt acknowledgment 1938 to the server 112 via a mobile vehicle (e.g., 170-180). When the server 112 receives the data receipt acknowledgment 1938, it stores the data receipt acknowledgment in data receipt acknowledgment 544 until it can be processed. When the server 112 processes the data receipt acknowledgment 544, it knows that the data that it transmitted earlier to the remote equipment 132 was received. The server 112 may then delete the data receipt acknowledgment 544 as soon as it has been processed. The machine 132 may delete the data receipt acknowledgment 1938 either after a period of time that is sufficient for delivery or may receive an acknowledgment of receipt of an acknowledgment from the server 112. Each acknowledgment specifically identifies the data that was received.

The server 112 may receive data from the machine (e.g., 132, 134, 152). There may be many machines. The server 112 may store the data from the machines in respective copies of data structure 540. Data received from remote machines may include health data and receipt acknowledgments. The data for a specific machine may be stored in its respective data 540. Data regarding the health of and receipt acknowledgments from the machine may be stored in its respective data 540 in health data 546 and data receipt acknowledgments 544.

### Machines Health Data

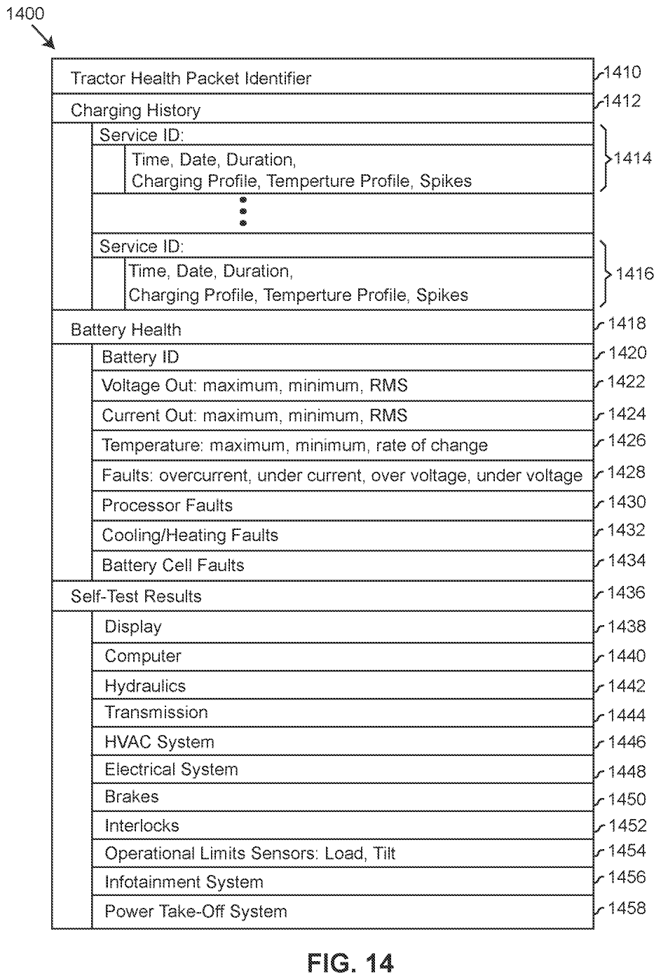

The health 1400 record as shown in FIG. 14 identifies some of the data related to the operation and the self-test results of a machine (e.g., 132, 134, 152). In an example embodiment, the computer 450 of machine 132 measures and collects the data shown in the health 1400 record. The machine sensors 1926 of the machine 132 measures and collects operational data related to the operation of the machine 132. The processing circuit 1920 of the computer 450 executes code (not shown) stored in the memory 1930 to test the components of the machine 132. The tests performed by the machine 132 on itself are referred to as self-tests. The processing circuit 1920 may cooperate with the sensors 1126 to run the self-tests and to collect the data related to the results of the self-tests.

The computer 450 of the machine 132 may store the data collected in the memory 1930 until the health data 1400 has been collected. Once the health 1400 record is been collected, it may be sent to the server 112. After the server 112 receives the data structure (e.g., record) health 1400, the server 112 stores the data structure for health 1400 in the data structure 540 created for the remote equipment 132 as the health data 546.

The health 1400 record represents some or all of the data that may be stored by the pieces of remote equipment (e.g., machines) 132, 134 or 152 as the health data. In an example embodiment, the health 1400 record includes data related to:

health packet identifier 1410;

charging history 1412;

battery health 1418; and

self-test results 1436.

The health 1400 record includes a health packet identifier 1410. Multiple versions of the health 1400 record may be prepared and eventually stored in health data 546 for the specific machine. The different versions of health 1400 record may represent operations performed and/or self-tests run on different dates or under different circumstances. The health packet identifier 1410 distinguishes between the different versions of the health 1400 record. The health packet identifier 1410 may include a timestamp. The health packet identifier 1410 may also include data to identify the remote machine (e.g., 132, 134, 152), the location of the remote machine, the date and time of creation of that version of the health 1400 record, the identity of the server (e.g., 112) to which the remote machine intends to send that version of the health 1400 record. Upon receipt of health 1400 record, the server 112 may store the data in the health data 546.

Charging history 1412 stores information related to each time the battery of the machines 132, 134 or 152 was charged. The charging history 1412 may have a plurality of entries (e.g., 1414, 1416). The computer 450 of the machine may create an entry each time the machine receives energy to charge its battery. An entry in the charging history 1412 may include:

a charging station ID that identifies the charging station that provided the energy;

the time, date and duration of the receipt of energy;

the charging profile used during delivery;

the temperature profile used during delivery; and

the spikes provided in the recharging current.

The battery health 1418 stores information related to the operation of the battery of the machine. In an example embodiment, the computer 450 of the machine 132 detects and stores the following data related to battery health 1418:
a battery identifier 1420 that identifies the battery in the machines. The battery identifier may include identifying information such as a serial number, the number of cells and the software revision number of the software executed by any processing circuits related to the battery;
voltage output levels 1422: maximum, minimum and/or RMS;
current output levels 1424: maximum, minimum and/or RMS;
temperature 1426: maximum, minimum, rate of change (e.g., slew rate);
faults in the operation of the battery 1428, such as, overcurrent, undercurrents, over voltages, under voltages;
faults in the operation of any of the processing circuits related to the battery 1430;
faults in the operation of the heating/cooling system 1432; and
faults in any of the battery cells or battery modules that make up the battery 1434.

The self-test results 1436 stores information related the results of self-tests performed by the processing circuit 1920 of the computer 450 in cooperation with the machine sensors 1926. Self-tests may test the operation of specific components of the machine 132. In an example embodiment, the self-test results include results of tests of:
a display (e.g., screen, monitor, indicator) used to provide information to or receive information from a user 1438;
the computer 450 1440;
the hydraulic systems 1442;
the transmission 1444;
the HVAC system 1446;
the electrical system 1448;
the brakes 1450;
any interlocks that control the operation of the machines to enhance safe operation or that protect the user 1452;
operational limit sensors, such as, overload sensors and tilt sensors 1454;
the infotainment system 1456; and
the power take-off system 1458.

### Deleting Acknowledgment Receipts

As discussed above, the server 112 generates an acknowledgment receipt upon receiving data from a piece of remote equipment 120-126, 132, 134 or 152. The acknowledgment receipt is sent by the server 112 to the piece of remote equipment that send the data. Until the piece of remote equipment that send the data receives the acknowledgment receipt, the piece of remote equipment retains the data in case it needs to be resent. When the piece of remote equipment that sent the data receives the acknowledgment receipt it may delete the data from its memory. The same applies to the server 112.

In an example embodiment, the remote equipment 152 transmits a health 1400 record to the server 112. When the mobile vehicle 176 passes the highway maintenance area 150, the computer 450 of the remote equipment 152 transmits the health 1400 record to the computer 250 of the mobile vehicle 176 via a short-range wireless link. Even though the remote equipment 152 has transmitted the health 1400 record, the computer 450 retains a copy of health 1400 record in case it needs to be resent.

The computer 250 of the mobile vehicle 176 receives and stores the health 1400 record in its memory 1830. The health 1400 record is physically transported everywhere that the mobile vehicle 176 travels. Eventually, when the mobile vehicle 176 enters the city 100, the health record 1400 has been transported to a location that provides access to long-range network 220. When the computer 250 of the mobile vehicle 176 detects that it can communicate with long-range network 220, the computer 250 establishes a short-range wireless link with the long-range network 220. The computer 250 transmits the health 1400 record to the server 112 via the short-range wireless link and the long-range network 220.

When the server 112 receives the health 1400 record, it stores health 1400 record in health data 546 of the data structure 540 that relates to the remote equipment 152. The server 112 generates an acknowledgment receipt acknowledging its receipt of the health 1400 record. The server 112 transmits the acknowledgment receipt to one or more mobile vehicles, for example the mobile vehicle 176, for physical transport and subsequent transmission to the remote equipment 152.

When the mobile vehicle that carries the acknowledgment receipt arrives within wireless range of the remote equipment 152, the computer 250 of the mobile vehicle transmits the acknowledgment to the remote equipment 152. Upon receiving the acknowledgment, the computer 450 of the remote equipment 152 uses the information in the acknowledgment to identify the data that corresponds to the acknowledgment receipt. Now that the acknowledgment receipt has been received, and the computer 450 knows that the server 112 has received the previously sent health 1400 record. The computer 450 may now delete the health 1400 record from its memory 1930 because the data will not need to be resent.

The same applies to the server 112 when it receives an acknowledgment receipt from a piece of remote equipment 120-126, 132, 134 or 152. Once the server 112 knows that the piece of remote equipment has received the data, it may delete the data from the data structure corresponding to the piece of remote equipment.

### Segmentation of Data for Transmission

As discussed above, data is physically transported to location where can be transmitted to its final destination. For example, the mobile vehicle 172 may physically transport data from the charging station 120 into the city 110. Once the mobile vehicle 172 reaches the city 110, the mobile vehicle 172 may establish a connection with the long-range network 220 and subsequently transmit the data to the server 112. So, the data from the charging station 120, that is intended for the server 112, is physically transported from the charging station 120, because charging station 120 cannot communicate directly with the server 112, to a place where the data can be transmitted to the server 112. This is what is referred to as physical transport and subsequent transmission.

In another example, the mobile vehicle 180 physically transports data from the server 112 for delivery to the remote equipment 132. After the mobile vehicle 180 has physically transported the data into wireless range with the remote equipment 132, the mobile vehicle 180 establishes the short-range wireless link 414 with the remote equipment 132 and transmits the data from the server 112 to its destination which is the remote equipment 132.

Data that is transmitted from a mobile vehicle to its destination, whether the destination be the server 112 or remote equipment 132, may be segmented for transmission so that the data may be transmitted as a series of segments. Segmenting data allows the mobile vehicle to successfully transmit at least some of the data that needs to be transmitted. Transmission of data and corresponding acknowledgment receipt may identify which segment has been transmitted and received so that the remaining segments may be transmitted at a later time or by a different mobile vehicle.

When the mobile vehicle transmits data to the server 112, segmenting data may be less important because the mobile vehicle is likely in range of the long-range network 220 for an extended period of time, so it is likely that the mobile vehicle will be able to transmit all of the data intended for the server 112.

However, when a mobile vehicle transmits data to remote equipment, the mobile vehicle may be merely passing through the remote location where the remote equipment is located. Further, factors (e.g., noise, interference, decreased band with link) may limit the amount of data that may be transmitted, via a short-range wireless link, from the mobile vehicles 170-180 to the remote equipment. Factors may include the speed of the vehicle, the distance between the highway and the remote equipment (e.g., signal strength), the topography of the surrounding terrain (e.g., hilly, flat), which may interfere with transmission and noise sources. Although short-range wireless links generally provide high-bandwidth communication, the duration of time available for communication and the signal strength of the transmission may be limited thereby limiting the amount of data that may be transferred from the mobile vehicles to the remote equipment.

A mobile vehicle may not be within radio range of the remote equipment for enough time to transmit the entire data set, but is in range long enough to transmit a portion of the data. Under such circumstances, segmenting the data for transmission will allow various mobile vehicles to transmit different segments until all segments have been received by the remote equipment. Even though all data may be segmented for transmission, firmware updates are likely to be large sets of data that need to be segmented for transmission from mobile vehicles to remote equipment.

In an example embodiment, the server 112 divides the data that is to be sent to a remote charging station and/or machine into segments (e.g., data segments, chunks, portions). The amount of data in each segment, or in other words the segment size, may depend on the remote equipment intended to receive the data, upon the communication protocol used to transmit the data, and/or the signal strength of the transmitters of the various mobile vehicles identified to physically transport and subsequently transmit the data.

For example, data segments intended for a piece of remote equipment that is close to a straight highway along flat ground may be larger than the data segments intended for a piece of remote equipment that is farther away from the highway that passes through hilly terrain. Segments transmitted by mobile vehicles that provide strong signals for transmission may handle larger data segments. The server 112 may track past delivery attempts to determine an appropriate segment size for a particular piece of remote equipment.

In an example embodiment, the server 112 prepares and stores segmented data 600. Segmented data includes segmented firmware update data 610 for the charging station 120 and segmented firmware updates 640 for the remote equipment 152. The server 112 prepares the segmented data 600 from firmware updates 512 and firmware update 542. The server 112 may segment and store any or all of the data of the data structure 500. Since each charging station has a respective data 510 and each machine has a respective data 540, the segmented data 600 may include segments for each instance of data 510 and/or data 540.

Charging station firmware updates 512 may be segmented and stored as data 610 that includes data segment 612, data segment 614, data segment 616 and data segment 618. Machine firmware updates 542 may be segmented and stored as data 640 that includes data segment 642 and data segment 644.

Each data segment may include a segment identifier that identifies the segment. A segment identifier may further identify the amount of data in the segment, the place of the data in a serial order of the segmented data, the total amount of data of all segments, and a total number of segments. Data 610 and data 640 may further include an identifier of the intended recipient remote equipment (120-126, 132, 134, 152) or server 112.

As discussed above, because a mobile vehicle 170-180 may generally store large amounts of data and the data may be transferred quickly from the server 112 to the mobile vehicle, and a mobile vehicle may carry all or a large portion of the segmented data prepared by the server 112 for transfer to multiple pieces of remote equipment 132, 134 and 152.

### Example Embodiments of Computers

As discussed above, each mobile vehicle 170-180 includes a respective computer 250. The computer 250 is mounted to the remote vehicle and remains in the remote vehicle. As the remote vehicle travels, the computer 250 travels with it. The computer 250 is used to receive data from remote equipment for physical transportation to an area where the data can be transmitted to the server 112. Each charging station includes a respective computer 330. Since the charging stations are not mobile, the computers 330 are fixed at a geographic location. Each machine 132, 134 and 152 includes a computer for 450. Even though the machines 132, 134 and 152 may be mobile, their range is limited and they are generally, at least for a period of time, positioned in a specific area and travel within a limited distance, so the computer 450 is not considered mobile.

In an example embodiment, the computer 250 includes a processing circuit 1820, a short-range wireless circuit 1822, a limited-range communication circuit 1824, vehicle sensors 1826 and a memory 1830. The memory 1830 may store authentication data 1832, the electric vehicle ID (e.g., identifier, number) 1834, and the data 1836. The data 1836 includes any data received from the server 112 for transport and subsequent transmission to remote equipment 120-126, 132, 134 or 152 and/or any data received from remote equipment for transport and subsequent transmission to the server 112. The authentication data 1832 may be used for the authentication of and secure communication with the server 112, the charging stations 120-126, the machines 132, 134 and 152, and/or the mobile vehicles 170-180.

In an example embodiment, the computer 330 includes a processing circuit 1720, a short-range wireless circuit 1722, a limited-range communication circuit 1724, charging station sensors 1726 and a memory 1730. The memory 1730 stores the authentication data 1732, the charging station ID 1734 (e.g., identifier, number), and the data 1736. The computer 330 may store any software, firmware updates and/or data it receives in the data 1736. The authentication data 1736 may be used for the authentication of and secure communication with the mobile vehicles 170-180 and/or machines 132, 134 and 152.

In an example embodiment, the computer 450 includes a processing circuit 1920, a short-range wireless circuit 1922, a limited-range communication circuit 1924, machine sensors 1926 and a memory 1930. The memory 1930 may store the authentication data 1932, the equipment ID (e.g., identifier, number) 1934, and the data 1936. The computer 450 may store any software, firmware updates and/or data it receives in the data 1936. The authentication data 1932 may be used for the authentication of and secure communication with the mobile vehicles 170-180, charging stations 120-126, and/or machines 132, 134 and 152.

The computer 250, the computer 330 and/or the computer for 50 may communicate with (e.g., transmit to, receive from) each other using the short-range wireless circuits 1822, 1722 and 1922 via a short-range wireless link (e.g., 210, 310, 410, 412, 414) or via wireless broadcast. Wireless communication via a short-range wireless links or broadcast may occur using any suitable short-range communication protocol. Any computer 250, 330 and 450 may communicate with one or more other computers 250, 330 and 450 at the same time.

The computer 250 of any mobile vehicle 170-180 may receive data from or provide data to the server 112 via the short-range wireless link 210. The computer 250 may store the data received from the server 112 or from remote equipment 120-126, 132, 134 or 152 in memory 1830 as the data 1836. The computer 250 may store data acknowledgment receipts in the data 1836. The computer 250 may retrieve data acknowledgment receipts from data 1836 for transmission to the intended piece of remote equipment 120-126, 132, 134 or 152 or to the server 112. The computer 250 of any mobile vehicle 170-180 may transmit some or all of the data 1836 using the short-range wireless circuit 1822. The computer 250 of a mobile vehicle 170-180 may communicate with the server 112 to transmit data to the server 112 or receive data from the server 112 via a short-term wireless link (e.g., 210) that provides access to long-range network 220 for communication with the server 112.

The computer 330 of any charging station 120-126 may receive data from or transmit data to a mobile vehicle 170-180 and/or any machine 132, 134 or 152 via a short-range wireless link (e.g., 310, 410, 412). The computer 330 stores data received from the mobile vehicle 170-180 and/or the machine 132, 134 or 152 in the data 1736 of the memory 1730.

The computer 450 of the machine 132, 134 or 152 may receive data from or transmit data to the mobile vehicle 170-180, the charging station 120-126 and/or any machine 132, 134 or 152 via a short-range wireless link (e.g., 412, 414). The computer 450 stores the data received from the mobile vehicles 170-180, the charging stations 120-126 and/or the machines 132, 134 or 152 in the data 1936 of the memory 1930.

The memory 1730, the memory 1830 and/or the memory 1930 may be secure memories. A secure memory may include a memory that is physically secure against tampering. A secure memory may include a memory that holds encrypted data to protect it from electronic tampering.

The computer 250, and therefore the memory 1830, is physically present on (e.g., connected to, mounted to) its respective the mobile vehicles 170-180. Because the computer 250 and memory 1830 are connected to its respective mobile vehicle 170-180, as the mobile vehicles 170-180 moves (e.g., travels), their respective computer 250 and memory 1830 move with the mobile vehicle, so the mobile vehicles physically transports the data in their respective computers 250 as the mobile vehicles 170-180 move around.

When the present disclosure states that the mobile vehicle 170-180, the charging station 120-126 and/or the machine 132, 134 and 152 communicate with each other, the communication is performed by their respective computers 250, 330 and 450 using their respective short-range wireless circuits 1822, 1722 and 1922.

Communication between a mobile vehicle 170-180, a charging station 120-126 and/or a machine 132, 134 and 152 may also occur via a limited-range communication link established by the limited-range communication circuit 1824, 1724 and/or 1924; however, the range and bandwidth is limited, so if at all possible, the short-range wireless circuit 1822, 1722 and/or 1922 is used instead.

Example of Data Transfer from the Server to Mobile Vehicle for Physical Transport

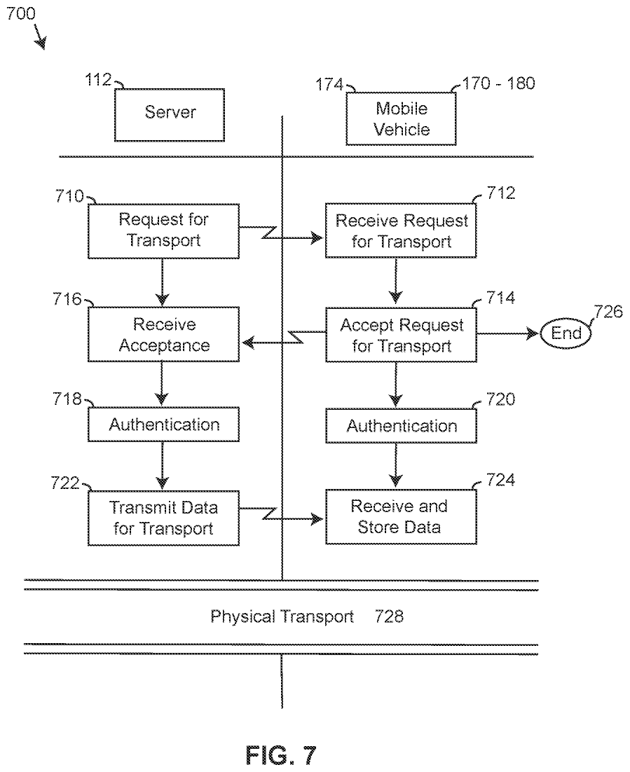

The diagram of FIG. 7 shows an example method 700, of how the server 112 transfers data (e.g., 512-514, 520, 522-526, 542-544, 548-552, 600) to a mobile vehicle 174 for physical transport and subsequent transmission to remote equipment 120-126, 132, 134 or 152. The data transferred may include data that is been segmented by the server 112. The example method 700 includes request 710, receive 712, accept 714, receive 716, authenticate 718, authenticate 720, transmit 722, receive 724 and physical transport 728.

In request 710, the server 112 transmits a request for transport (e.g., transportation of data). The request for transport is transmitted broadly (e.g., broadcast, not one-on-one) to all vehicles that are presently connected to long-range network 220 via their respective short-range wireless links, so many vehicles may receive the request for transport. In another embodiment, the server 112 may serially establish a one-to-one communication link with the mobile vehicles connected to the long-range network 220.

For clarity, broadcast means to transmit from one device (e.g., server, charging station, machine) to many devices. One or more devices may respond to a broadcast. A broadcast may be transmitted over wired and/or wireless medium. A communication link, whether long-range, short-range, wired or wireless, is established for one-to-one communication in which one device communicates with another device. The term broadcast means the transmission of data without acknowledgment of receipt and/or without knowledge as to whether another device is present to receive the transmission. Data that is broadcast may be received by any device that is in range. Data may be broadcast without authentication.

In receive 712, one or many mobile vehicles 170-180 receives the request to transport from the server 112. In this example, the mobile vehicle 174 receives the request. Other mobile vehicles may receive the request and respond as a mobile vehicle 174 does in this example. Execution moves to accept 714.

In accept 714, the mobile vehicle 174 determines whether it will accept the request to transport the data. In determining whether to accept the request to transport, the mobile vehicle 174 may determine whether has a room in its memory 1830 to store the data. The request for transport may include a geographic destination of the data. The mobile vehicle 174 may determine that its likelihood of traveling to that geographic destination is so low that it likely will not be able to deliver the data. In the event that payment is provided for the transport of data, the mobile vehicle 174 may determine whether the renumeration is sufficient. There may be other factors that the mobile vehicle 174 uses to determine whether it should accept the request to transport the data.

If the mobile vehicle 174 determines that it will accept the request to transport the data, the mobile vehicle 174 transmits an acceptance to the server 112 and execution moves to authenticate 720. If the mobile vehicle 170 determines that it will not accept the request to transport the data, the mobile vehicle 174 does not transmit the acceptance and execution moves to end 726.

In receive 716, the server 112 receives the acceptance from the mobile vehicle 174. Execution moves to authenticate 718.

In authenticate 718 and authenticate 720, the server 112 and the mobile vehicle 172 authenticate themselves to each other. Authentication between the server 112 and the mobile vehicle 174 may occur in any manner using any technique. The communication required between the server 112 and the mobile vehicle 174 to perform authentication is not shown. Authentication may include establishing a secure communication link for subsequent communication between the server 112 in the mobile vehicle 174. After authentication 718 and authentication 720 are successfully performed, execution for the server 112 moves to transmit 722 and execution for the mobile vehicle 174 moves to receive 724.

In transmit 422, the server 112 transmits the data to the mobile vehicle 174 that is to be transported by the mobile vehicle 174. The transmission occurs via the long-range network 220 and the short-range wireless link 210. The data may be transmitted as a single data set or multiple data sets (e.g., packets) using any communication protocol. The data transmitted by the server 112 may be segmented data. In receive 724, the mobile vehicle 174 receives the data from the server 112. The transmission and reception of the data for transport may be accomplished using any communication protocol and may include any form of acknowledgments to ensure that the data is correctly transmitted and received.

In receive 724, the computer 250 of the mobile vehicle 174 further stores the received data in data 1836 in its memory 1830. All of the data to be transported is stored in the memory 1830.

In physical transport 728, the mobile vehicle 174, it is computer 250 and the data goes wherever it is driven by the driver. Because the computer 250 and therefore the memory 1830 is physically attached to the mobile vehicle 174, the data stored in data 1836 is transported to wherever the vehicle goes.

As the mobile vehicle 174 travels, it seeks for the presence of remote equipment (e.g., 120-126, 132, 134, 152). The mobile vehicle 174 may search for remote equipment using its short-range wireless circuit 1822. The mobile vehicle 174 may send out (e.g., broadcast) requests to connect to determine whether the computers of any remote equipment are within radio range. In another example embodiment, the computer 250 of the mobile vehicle 174 knows the approximate geographic location of the remote equipment that is to receive the data, so when the mobile vehicle 174 is in the area of the geographic location it begins to search for the remote equipment.

The example method 700 of FIG. 7 may be repeated any number of times to transmit data to any number of the mobile vehicles 170-180. As discussed herein, transmitting the data to many mobile vehicles may increase the likelihood that the data will be delivered to the intended piece of remote equipment. For example, while the mobile vehicles 170-180 are in city 110, the server 112 may transfers data to all of the mobile vehicles 170-180. The respective computers 250 of the mobile vehicles 170-180 store the data as data 1836 in their respective memories 1830. In this example, the mobile vehicles 170-180 then drive out of the city 110 in various directions. Eventually, one or more of the mobile vehicles 170-180 drives past the piece of remote equipment that is the intended recipient of some or all of the stored data. Upon finding an intended recipient, the computer 250 of the mobile vehicle transmits the data from data 1836 to the intended recipient.

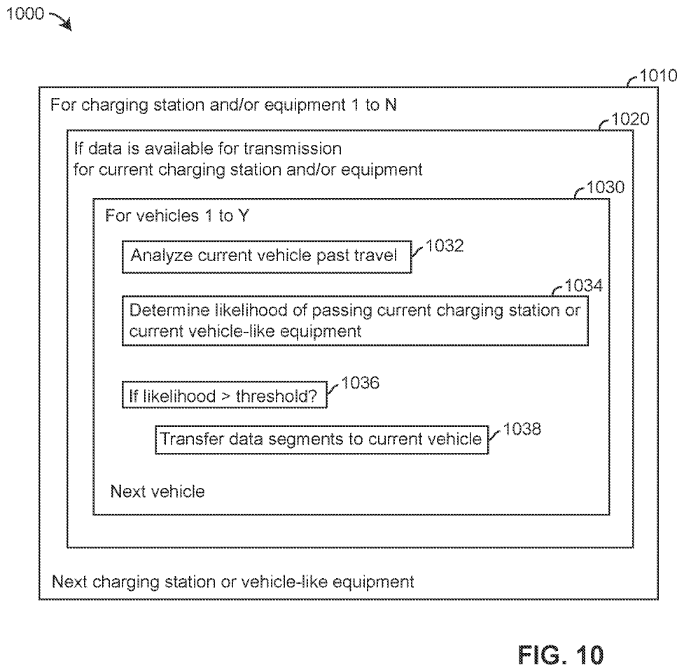

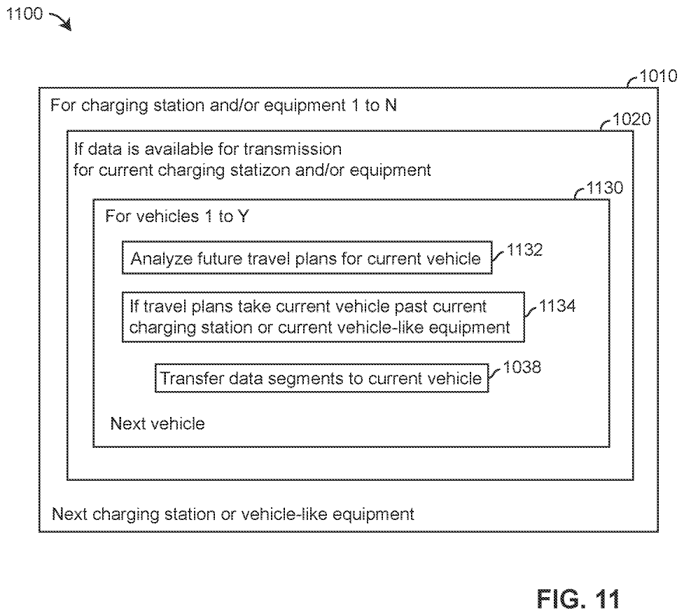

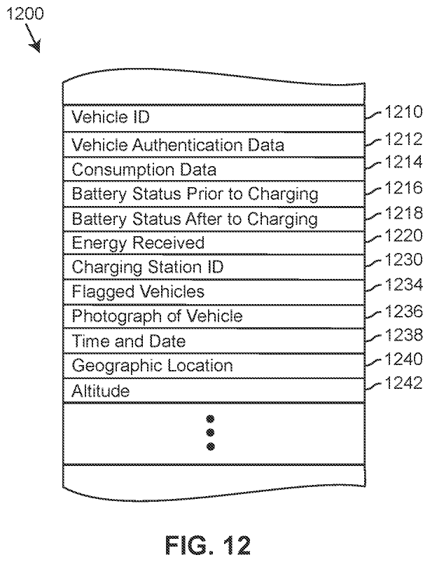

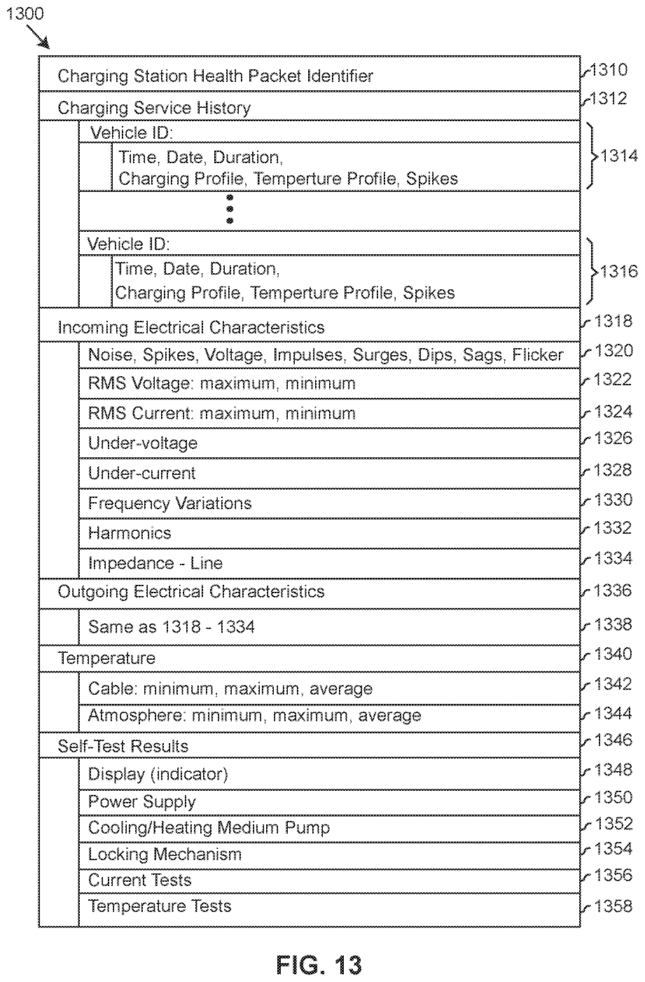

Example embodiments of methods of how the server 112 determines whether or not to transfer the data to a specific mobile vehicle are shown in FIGS. 10 and 11.

Example of Data Transfer from Mobile Vehicle to Remote Equipment after Physical Transport

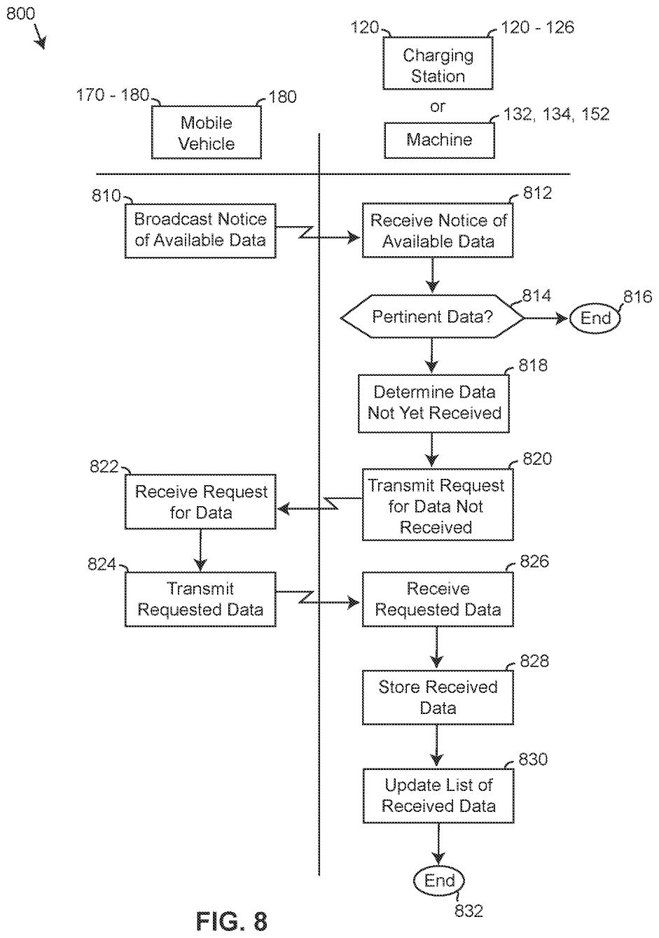

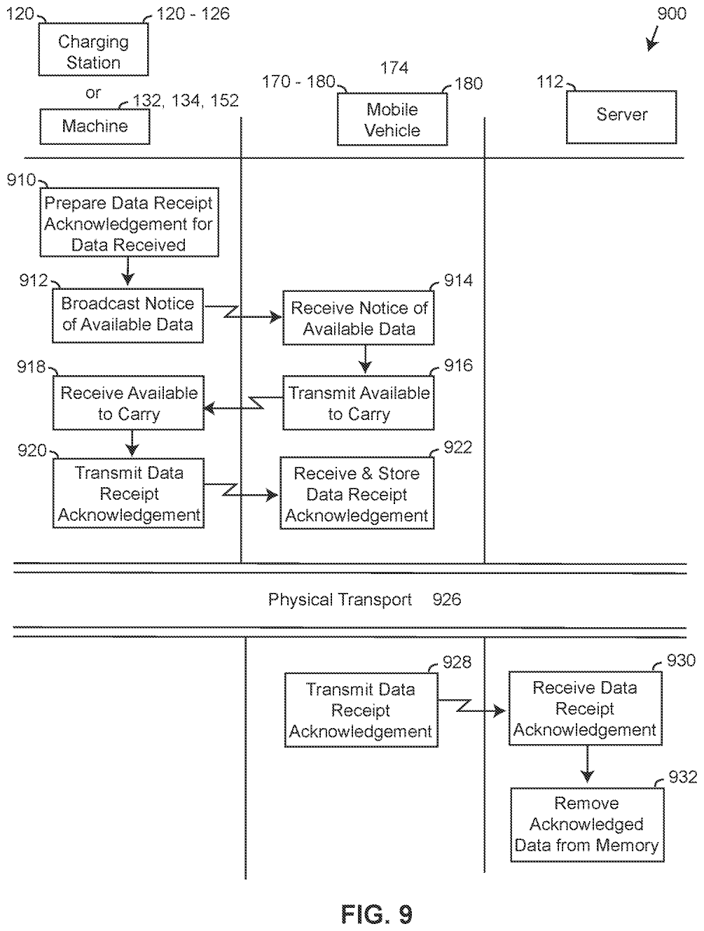

The example method 800, of FIG. 8, shows how a mobile vehicle 170-180, in particular mobile vehicle 180, transfers data to remote equipment (e.g., 120-126, 132, 134, 152), in particular charging station 120, after the data has been transported to the location where charging station 120 is located.

The example method 800 begins after the mobile vehicle 180 has physically transported (e.g., physical transport 728) the data into wireless range of the charging station 120, so the step physical transport 728 is not shown in the example method 800. In this example method, mobile vehicle 180 transmits data to the charging station 120 via the short-range wireless link 410. The example method 800 includes broadcast 810, receive 812, pertinent 814, end 816, determine 818, transmit 820, receive 822, transmit 824, receive 826, store 828, update 830 and end 832.

Authentication of the mobile vehicle 180 with the charging station 120 may occur at any suitable point the example method 800 and is not shown. Encryption may be used to secure communications.

In broadcast 810, the mobile vehicle 180 broadcasts a notice using its short-range wireless circuit 1822 that it has available data. The notice includes information identifying the remote equipment for which the mobile vehicle has data. The notice may include the type of data. The notice may include information as to which segments it has available from a segmented data set. In another example embodiment, the mobile vehicle 180 knows that it has information is for charging station 120, so in lieu a broadcasting a notice of available data, the mobile vehicle 180 may establish a short-range wireless link 410 with the charging station 120 then send the notice.

In receive 812, the charging station 120 receives the notice of available data.

In pertinent 814, the computer 330 of the charging station 120 inspects the notice of available data to determine whether the data is pertinent to (e.g., intended for) the charging station 120. If the notice is sent via broadcast, the charging station 120 checks the notice to determine whether any of the data is intended for the charging station 120. If none of the data carried by the mobile vehicle 180 is intended for the charging station 120, the charging station 120 ignores the notice and execution moves to end 816. If some of the data is intended for the charging station 120, then execution moves to determine 818.

In determine 818, the charging station 120 determines whether it has previously received some or all of the data. The notice of available data includes information as to the type of data or the segment numbers of segmented data. If the charging station 120 has already received all of the data (e.g., from a prior passing mobile vehicle), then the charging station 120 may either not respond to the request and let execution move to end 816 or the charging station may send (not shown) an acknowledgment to the mobile vehicle 180 for transport and subsequent transmission to the server 112 to inform the server 112 that it has already received the data. If the charging station 120 has not receive at least some of the data carried by the mobile vehicle 180, execution moves to transmit 820.

In transmit 820, the charging station 120 transmits a request that the mobile vehicle 180 send the data or at least a portion thereof. The request may identify the data that is to be transmitted, so the data that it has already received is not transmitted.

In receive 822, the mobile vehicle 180 receives the request for data. The mobile vehicle 180 analyzes the request to determine which data should be transmitted.

In transmit 824 and receive 826, the mobile vehicle 180 transmits and the charging station 120 receives the data requested by the charging station 120. The transmission or reception of data may be done using any communication protocol. Multiple steps, not shown, may be required to transmit and receive all of the data. Transmission and reception may include acknowledgment and/or retransmission if needed. Once the charging station 120 has received the data, or as it receives the data, the computer 330 of the charging station 120 executes store 828 to store the data in its memory 1730 as data 1736.

Transmit 824 and receive 826 may be performed for small chunks of data (e.g., segment) so that the transmission and reception may be completed before the mobile vehicle 180 drives out of range of the short-range wireless link 410. As discussed before, server 112 may segment data to increase the likelihood of successful transmission and reception. Transmit 824 and receive 826 continue until all of the data is transmitted and received or the short-range wireless link 410 is lost.

After the transmission or reception is complete or when the short-range wireless link 410 is lost, the charging station 120 executes update 830. In update 830, the charging station 120 updates the list of data that it has received. The list may also include data that the charging station 120 knows about, but has not yet received. The list of received data may be stored in memory 1730. The charging station 120 may also create one or more acknowledgment messages for the data received. The charging station 120 may store the one or more acknowledgment messages in memory 1730 for sending to the server 112 when possible.

Example of Data Transfer from the Server to Remote Equipment

The example methods 700 and 800 may be combined to perform a transfer of data from the server 112 to the charging station 120. The combination provides an example for transferring data by physical transport and subsequent transmission from the server 112 to the charging station 120. The example method 700 is performed at a first location where the mobile vehicle 180 can communicate with the server 112 via the long-range network 220. The example method 800 is performed at a remote location where the charging station 120 is positioned. The combined example method is described below as the steps performed by the mobile vehicle 180 and the charging station 120.

The mobile vehicle 180 performs the following steps. While the mobile vehicle 180 is positioned at the first location, the computer 250 of the mobile vehicle 180 receives data from the server 112 for transfer to the charging station 120 position at the remote location. The charging station 120 cannot communicate with the long-range network 220 or the server 112 because it is positioned at the remote location. The computer 250 of the mobile vehicle 180 stores the data it receives from the server 112 in memory 1830. The computer 250 is physically connected to the mobile vehicle 180. The mobile vehicle 180 travels from the first location to the remote location and into a wireless range of the charging station 120. Because the mobile vehicle 180 travels from the first location to the remote location, it physically transports the computer 250 and the data from the first location and to within the wireless range of the charging station 120. The computer 250 of the mobile vehicle 180 broadcasts, via a first short-range wireless transmission, a notice of available data. The notice of available data includes an identifier of the charging station 120 (e.g., the intended recipient) and a description of the data.

The charging station 120 performs the following steps. The charging station 120 receives, via the first short-range wireless transmission, the notice of available data. The computer 330 of the charging station 120 determines in accordance with the identifier and the description of the data that the data is (e.g., intended) for transfer to the charging station 120. The computer 330 of the charging station 120 also determines that the data has not previously been received. The computer 330 of the charging station 120 transmits, via a second short-range wireless transmission, a request for the data. The computer 330 of the charging station 120 receives, via a short-range wireless link 410, the data in accordance with the request for the data thereby completing the physical transport and subsequent transmission of the data from the server 112 to the charging station 120.

In addition to the above, the charging station 120 (e.g., computer 330 thereof) creates a data receipt acknowledgment responsive to receiving the data. The data receipt acknowledgment includes the description of the data, the identifier of the charging station 120 and a date (e.g., day, month, year, time) the data was received. The computer 330 of the charging station 120 stores the data receipt acknowledgment in the memory 1730 for later transfer by physical transport and subsequent transmission to the server 112. In an example embodiment of a method, the computer 330 of the charging station 120 transmits the data receipt acknowledgment to the mobile vehicle 180 via the short-range wireless link 410 for transfer by physical transport and subsequent transmission to the server 112. The computer 250 of the mobile vehicle 180 stores the data receipt acknowledgment in the memory 1830 for transfer to the server 112.

In another example method, the data transmitted by the mobile vehicle 180 to the charging station 120 is divided into two or more segments. Each segment includes a segment identifier. The notice of available data further includes the segment identifiers of the two or more segments. The charging station 120 determines whether to receive the data in accordance with the segment identifiers of the two or more segments. In the event that the data is intended for the charging station 120, the request for data provided by the charging station 120 to the mobile vehicle 180 includes one or more of the segment identifiers for segments that have not previously been received by the charging station 120.

In another example method, the example methods 700 and 800 are combined and performed by the mobile vehicle 180 and the charging station 120 while the charging station 120 is recharging the battery of the mobile vehicle 180 (see FIG. 3).

The combined methods 700 and 800 may also be used for the mobile vehicle 180 to transfer data to the machine 132 positioned in the remote location. The mobile vehicle 180 may be used to physically transport and subsequently transmit data from the server 112 to the remote equipment 132. The mobile vehicle 180 includes the computer 250. The computer 250 includes the memory 1830. The computer 250 is attached to the mobile vehicle 180 so the mobile vehicle carries the first computer 250 with it as it travels. While the mobile vehicle 180 is positioned at the first location, the computer 250 is adapted to (a) communicate with the server 112 via the long-range network 220; (b) receive the data from the server 112 via the long-range network 220, the data includes the identifier of the remote equipment 132 intended to receive the data; and (c) store the data in the memory 1830.

After the computer 250 stores the data, the mobile vehicle 180 is adapted to travel from the first location to the remote location. As the mobile vehicle 180 travels from the first location to the remote location, the mobile vehicle is configured to physically transport the computer 250 and thereby the data from the first location to the remote location. As discussed above, the machine 132 is positioned at the remote location. While the machine 132 is positioned at the remote location, the machine 132 cannot communicate with the long-range network 220 or the server 112.

Once the mobile vehicle 180 arrives at the remote location and while the mobile vehicle 180 is positioned at the remote location (i) the mobile vehicle 180 cannot communicate with the long-range network 220 or the server 112; (ii) the computer 250 is adapted to transmit the data to the machine 132 via a short-range wireless link 414 thereby completing physical transport and subsequent transmission of the data from the server 112 to the machine 132.

During its travels from the first location to the remote location, the driver of the mobile vehicle 180 controls the timing and the route of travel between the first location and the remote location. The server 112 does not specify the timing and/or the route of travel between the first location and the remote location. In other words, the route of travel of the mobile vehicle 180 is outside of control of the server 112 or any other entity or person other than the driver of the mobile vehicle 180. It is possible that the driver of the mobile vehicle 180 decides to not drive to or past the remote location. It is also possible that the driver of the mobile vehicle 180 frequently drives to or past a remote location, so it is highly likely that the driver the mobile vehicle 180 will drive to or past the remote location again thereby physically transporting and subsequently transmitting the data to the machine 132.

### Example of Transfer of Data Receipt Acknowledgement

As discussed above, when remote equipment 120-126, 132, 134 or 152 receives data from the server 112 via physical transport of data and subsequent transmission by a mobile vehicle 170-180, the remote equipment prepares a data receipt acknowledgment for physical transport and subsequent transmission to the server 112. The data receipt acknowledgment informs the server 112 that the remote equipment received the data. An example embodiment of a method, example method 900, shows how the remote equipment 120-126, 132, 134 or 152, the mobile vehicles 170-180 and the server 112 cooperate to create, transport and transmit data receipt acknowledgments from the remote equipment 120-126, 132, 134 or 152 to the server 112. The machine 132 and mobile vehicle 180 are used below to illustrate the example method 900.

The example method 900 includes prepare 910, broadcast 912, receive 914, transmit 916, receive 918, transmit 920, receive 922, physical transport 926, transmit 928, receive 930, and remove 932. Prior to the start of example method 900, the machine 132 has received some data from the server 112 via a mobile vehicle 170-180. The mobile vehicle that delivered the data to the machine 132 can be any of the mobile vehicles 170-180 and does not necessarily need to be the mobile vehicle 180. It is possible that the mobile vehicle 170 drove past the mining operation 130 and delivered the data to the machine 132, but continued on its way before the machine 132 could generate the data receipt acknowledgment and transmit it to the mobile vehicle 170. So, the machine 132 stores the data receipt acknowledgment until it can be transmitted to mobile vehicle 180.

In prepare 910, the computer 450 of the machine 132 prepares the data receipt acknowledgment for the data received. As discussed above, the data receipt acknowledgment may include a description of the data that was received. It may further include the date and time of receipt. If a mobile vehicle 170-180 is not available to receive the data receipt acknowledgment immediately after it is created, the computer 450 of the machine 132 stores the data receipt acknowledgment in its memory 1930 for later transmission. Execution moves to broadcast 912.

In broadcast 912, the computer 450 of the machine 132 broadcasts a notice that it has data available for transmission. The notice may be transmitted broadly to all vehicles that are presently within the radio signal range of the short-range wireless circuit 1922. The machine 132 may repeatedly broadcast the notice until it gets a response. If a response is not received within a threshold amount of time, the machine 132 may wait until it receives a notice from a mobile vehicle 170-180 that it is in the area.

In receive 914, the computer 250 of the mobile vehicle 180 receives the notice of available data. The notice of data available may include information regarding the amount of data available for transport. The mobile vehicle 180 determines whether it can receive the data for transport.

In transmit 916, the mobile vehicle 180 transmits a notice that it is available to carry the data.

In receive 918, the machine 132 receives the notice that the mobile vehicle 180 is available to carry the data receipt acknowledgment.

In transmit 920, the machine 132 transmits the data receipt acknowledgment to the mobile vehicle 180. The data receipt acknowledgment is transmitted, as with all previous communications between the machine 132 and the mobile vehicle 180, via the short-range wireless link 414.

In receive 922, the computer 250 of the mobile vehicle 180 receives the data receipt acknowledgment from the machine 132 and stores it in data 1836 in its memory 1830. After receipt, the mobile vehicle 180 continues on its journey. As the mobile vehicle 180 travels, it carries with it the computer 250 which includes the memory 1830. The very act of travel while carrying the computer 250 that stores the data receipt acknowledgment performs the physical transport 926.

Eventually, the mobile vehicle 180 arrives at city 110 where the computer 250 has access to the long-range network 220. The computer 250 of the mobile vehicle 180 establishes contact with the server 112 via a short-range wireless link 210 and the long-range network 220.

In transmit 928, the computer 250 of the mobile vehicle 180 transmits the data receipt acknowledgment to the server 112. The computer 250 of the mobile vehicle 180 is not limited to transmitting solely the data receipt acknowledgment. While the computer 250 has contact with the server 112, the computer 250 may transmit any and all data that it has received, stored and transported from any piece of remote equipment 120-126, 132, 134 or 152.

In receive 930, the server 112 receives the data receipt acknowledgment. The server 112 may use the information from the data receipt acknowledgment to determine the data that was received by the machine 132.

In remove 932, the server 112 may, but is not required, to remove the data that it earlier transmitted that has now been received by the machine 132. For example, if the server 112 had sent service instructions 552 to the machine 132, now that the machine 132 has acknowledged receipt, the server 112 may delete the service instructions 552. The server 112 may also retain a record of what is been sent and received, so it knows what does not need to be retransmitted. Keeping a record means that the server 112 does not need to delete data that is been received.

Example of Data Transfer from Remote Equipment to Server

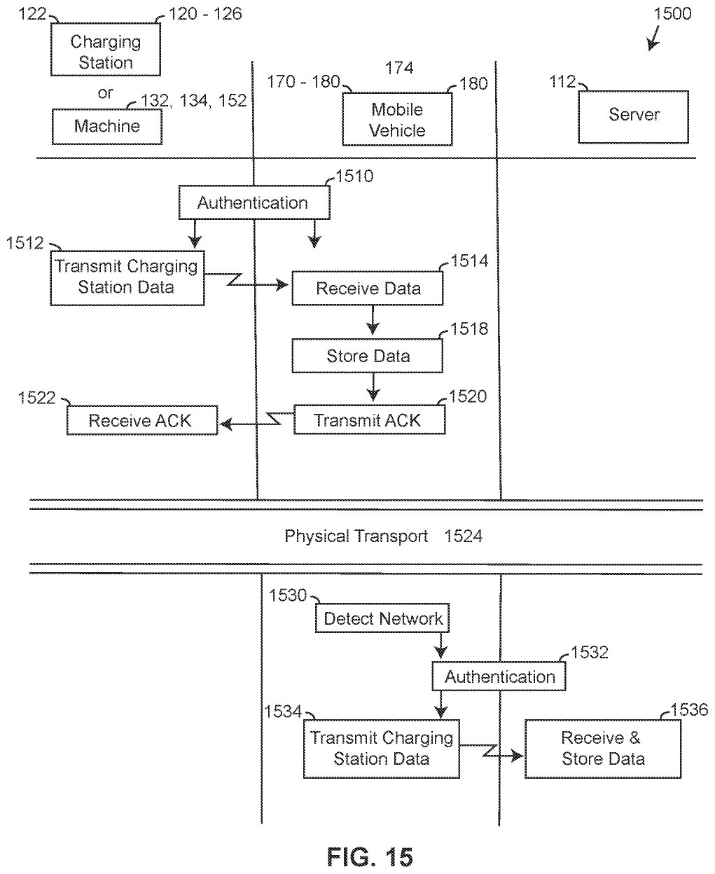

An example embodiment of a method of transferring data from remote equipment 120-126, 132, 134 and/or 152 is shown in FIG. 15 and is identified as example method 1500. The example method 1500 is described below in terms of charging station 120 sending data to the server 112 via mobile vehicle 180. The example method 1500 includes transmit 1512, receive 1514, store 15115, ACK transmit 1520, ACK receive 1522, physical transport 1524, detect 1530, authenticate 1532, transmit 1534 and receive 1536.

The example method 1500 may include authenticate 1510. In authenticate 1510, the charging station 120 and the mobile vehicle 180 authenticate themselves to each other. Authentication may be accomplished using any algorithm, protocol or technique.

In transmit 1512, the computer 330 of the charging station 120 transmits data to the computer 250 of the mobile vehicle 180. Prior to transmitting the data, the charging station 120 establishes the short-range wireless link 410 with the mobile vehicle 180. Establishing the short-range wireless link 410 may be accomplished in any manner. The charging station 120 may transmit any data to the mobile vehicle 180 that should be sent to the server 112. The data may include zero or more financial transaction 1200, zero or more health 1300 and/or zero or more data receipt acknowledgments. The data may be segmented to facilitate transfer. Prior to transmitting the data, the charging station 120 and/or the mobile vehicle 180 may send notices of availability or take any actions to establish a wireless connection for communication.

In receive 1514, the computer 250 of the mobile vehicle 180 receives the data from the computer 330 of the charging station 120 via the short-range wireless link 410.

In-store 1518, the computer 250 of the mobile vehicle 180 stores the received data in data 1836 in its memory 1830.

In ACK transmit 1520, the computer 250 of the mobile vehicle 180 transmits an acknowledgment to confirm receipt of the data. The acknowledgment may identify the data that is been received.

In ACK receive 1522, the computer 330 of the charging station 120 receives the acknowledgment thereby confirming to the charging station 120 that the data it transmitted was received by the computer 250 of the mobile vehicle 180. ACK transmit 1520 and ACK receive 1522 may be performed in any manner using any communication protocol.

In physical transport 1526, the mobile vehicle 180 physically transports the received data. Because the computer 250 is attached to the mobile vehicle 180, as the mobile vehicle 180 moves, the received data also moves. Eventually, the mobile vehicle 180 arrives in the city 110, thereby completing the physical transport 1526, because in the city 110, the mobile vehicle 180 can communicate with the server 112 via the long-range network 220.

In detect 1530, the computer 250 of the mobile vehicle 180, while it is situated in the city 110, detects the long-range network 220. The computer 250 may use any technique to detect that the long-range network 220 is available and that the mobile vehicle 180 can connect to it to communicate with the server 112.

After the computer 250 of the mobile vehicle 180 has determined that it can communicate with the server 112 via the long-range network 220, the computer 250 and the server 112 may perform authentication 1532 to authenticate themselves to each other. As discussed above, authentication may be accomplished using any algorithm, protocol or technique.

In transmit 1534, the computer 250 of the mobile vehicle 180 transmits the data received from the charging station 120 to the server 112. If the mobile vehicle 180 received the data in segments, it may transmit the data to the server 112 in segments.

In receive 1536, the server 112 receives the data from the mobile vehicle 180 and stores the data in the data 510 of associated with the charging station 120.

Because the server 112 has received data, the server 112 also generates a data receipt acknowledgment. The data receipt acknowledgment is intended to be sent to the charging station 120 to inform the charging station 120 that its data was received. The server 112 creates and stores the data receipt acknowledgment in the data receipt acknowledgment 514 for transmission to the charging station 120 when possible. Since the mobile vehicle 180 will likely be within range of the long-range network 220 for a period of time as it travels through the city 110, it is possible that the server 112 may generate the data receipt acknowledgment and transmit the data receipt acknowledgment to the mobile vehicle 180 for physically transport and subsequent transmission to the charging station 120. If the mobile vehicle 180 is not available to receive and transport the data receipt acknowledgment, the server 112 sends the data receipt acknowledgment with the next available mobile vehicle 170-180.

Another Example of Data Transfer from Remote Equipment to Server

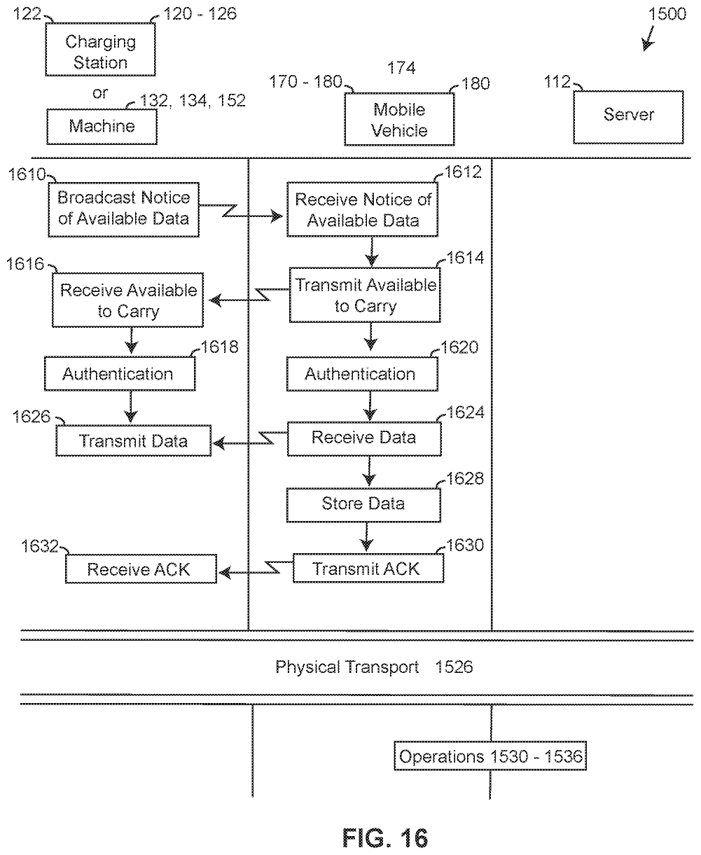

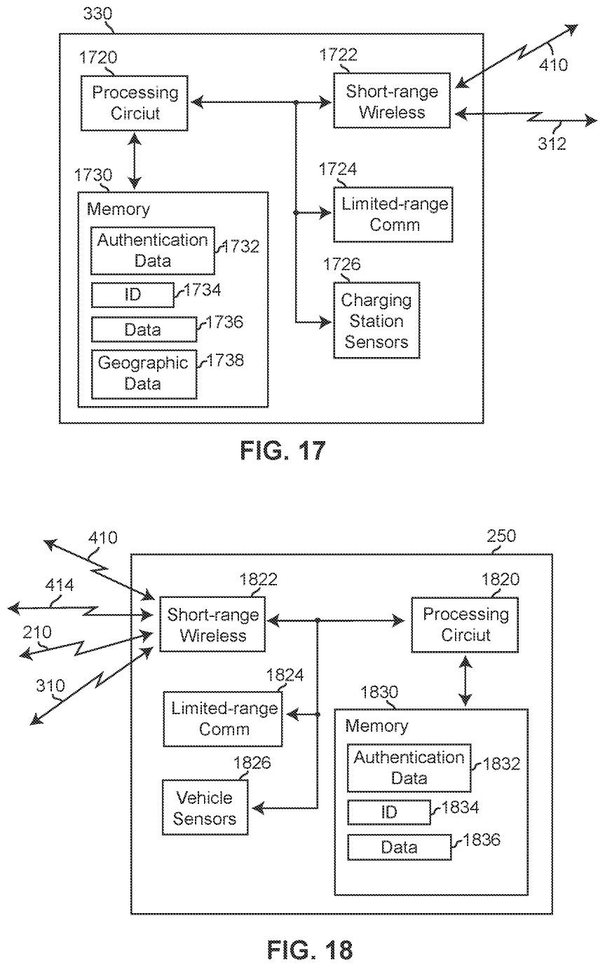

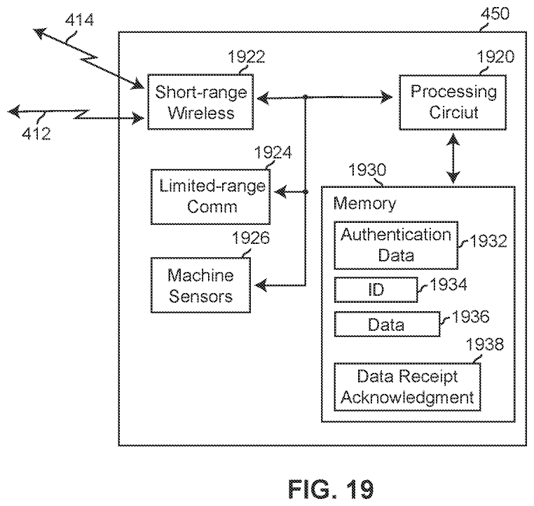

Another example method of transferring data from remote equipment 120-126, 132, 134 and 152 to server 112 is shown in FIG. 16 and identified as example method 1600. The example method 1600 is described below in terms of the charging station 122 sending data to the server 112 via the mobile vehicle 178. Example method 1600 includes broadcast 1610, receive 1612, transmit 1614, receive 1616, authenticate 1618, authenticate 1620, receive 1624, transmit 1626, store 1628, ACK transmit 1630, ACK receive 1632, physical transport 1526 and operations 1530-1536 from example method 1500.

In broadcast 1610, the computer 330 of the charging station 122, further referring to FIG. 3, broadcasts a notice that it has data available for transfer by physical transport and subsequent transmission.

In receive 1612, the mobile vehicle 178 receives the notice.

In transmit 1614, the mobile vehicle transmits a notice that it is available to receive and transport the data the charging station 122.

In receive 1616, the charging station 122 receive the notice from the mobile vehicle 178 that mobile vehicle 178 is available to transport the data.

In authenticate 1618 and authenticate 1620, the charging station 122 and the mobile vehicle 178 authenticate themselves to each other. As discussed above authentication may be accomplished in any manner using any protocol.

In transmit 1626, the charging station 122 transmits the data to the mobile vehicle 178 via the short-range wireless link 310. The data that charging station 122 has for transmitting to the mobile vehicle 178 includes any data regarding financial transactions 1200, health 1300 and/or data receipt acknowledgments.

In receive 1624, the mobile vehicle 178 receives the data from the charging station 122 via short-range wireless link 310.

In store 1628, the computer 250 of the mobile vehicle 178 stores the data in data 1836 in memory 1830. The memory 1830 may be a secure memory. The data may be stored in memory 1830 in any manner and in any format.

In ACK transmit 1630, the computer 250 of the mobile vehicle 178 transmits an acknowledgment that it received the data from the computer 330 of the charging station 122. The acknowledgment is transmitted via the short-range wireless link 310.

In ACK receive 1632, the charging station 122 receives the acknowledgment. If the charging station does not receive an acknowledgment within a specified period of time, the charging station may restart the example method at broadcast 1610.

The communication between the computer 250 of the mobile vehicle 178 and the computer 330 of the charging station 122 may be accomplished using any communication protocol which may or may not transmit an acknowledgment to verify the receipt of data.

In physical transport 1526, the mobile vehicle 178 physically transports the received data as discussed above with respect to physical transport 1526.

Physical transport 1526, detect 1530, authenticate 1532, transmit 1534 and receive 1536 are described with respect to example method 1500. In an example method 1600, the mobile vehicle 178 perform the physical transport of the data by physically transporting the data as it is stored in memory 1830 of the computer 250 which is connected to the mobile vehicle 178. Mobile vehicle 178 and the server 112 cooperate to perform the operations 1530-1536 while the mobile vehicle 178 is in the vicinity of the city 110 and able to communicate with the server 112 via the long-range network 220. The mobile vehicle 178 transmits the data received from the charging station 122 to the server 112.

### Identifying Mobile Vehicles for Data Transport and Transmission

In a situation in which the mobile vehicles 170-180, the charging stations 120-126 and the machines 132, 134 and 152 are manufactured by the same manufacturer or receive after-market support from the same provider, the server 112 may be used to provide additional services other than the transmission of data to remote equipment. Services may include providing maintenance, finding warranty services, aiding and navigation, providing or arranging infotainment sources, and/or providing emergency services. In order to provide services to the mobile vehicles 170-180, the charging stations 120-126 and the machines 132, 134 and 152, the server 112 maintains records.

In an example embodiment, the server 112 maintains records regarding the owner, operators, firmware version, operation, recharging, health, repairs, past travel, and possibly the intended future travel of each mobile vehicle 170-180. The server 112 maintains records regarding the owner, firmware version, geographic location, operation, health, repairs and the vehicles serviced by each charging station 120-126. The server 112 maintains records regarding the owner, operators, firmware version, geographic location, operation, recharging, repairs and health of each machine 132, 134 and 152.

The server 112 may use the information from the records that it maintains to identify mobile vehicles for physical transport and subsequent transmission of data between the server 112 and one or more pieces of remote equipment. When the server 112 has data available for transport and subsequent transmission to remote equipment 120-126, 132, 134 or 152, the server 112 may use example methods 1000 and 1100 of FIGS. 10-11 to identify suitable mobile vehicles 170-180 for transporting and transmitting the data to the remote equipment. Upon identifying a suitable mobile vehicle 170-180, the data that is to be transferred to the remote equipment is transmitted via the long-range network 220 to the mobile vehicle for physical transport (e.g., method 700). After the data has been physically transported by the mobile vehicle, the mobile vehicle subsequently transmits the data to the appropriate piece of remote equipment (e.g., method 800).

The example method 1000 identifies suitable mobile vehicles for transporting and subsequently transmitting data by analyzing the past travel of the mobile vehicles. The example method 1100 identify suitable mobile vehicles for transporting and subsequently transmitting data by analyzing the future travel plans of the mobile vehicles.

The example method 1000 includes for loop 1010, if available 1020, for loop 1030, analyze 1032, determine 1034, if likelihood 1036 and transfer 1038.

In for loop 1010, the server 112 has a list of N pieces of remote equipment (e.g., 120-126, 132, 134, 152). The server 112 wants to determine if any data is available to send to any of the N pieces of remote equipment on the list. The server 112 processes each piece of remote equipment on the list one at a time. When if 1020 and for loop 1030 have been executed for the current piece of remote equipment being processed, the server 112 moves to the next piece of remote equipment on the list until all N pieces of remote equipment have been processed. For loop 1010 may be implemented as a “for” loop in many software languages.

In if available 1020, the server 112 determines whether there is data available for transfer to the piece of remote equipment that is currently being processed from the list. If there is data available for transfer to the current piece of remote equipment, for loop 1030 is executed. If there is no data available for transfer to the current piece of remote equipment, for loop 1030 is not executed and server 112 moves to the next piece of remote equipment on the list. If available 1020 may be implemented as an “if” statement in many software languages.

In for loop 1030, the server 112 has a list of Y mobile vehicles 170-180. The server 112 wants to determine if any of the Y mobile vehicles are suitable for physically transporting and subsequently transmitting data to the current piece of remote equipment being evaluated. The server 112 processes each mobile vehicle from the list of mobile vehicles one at a time to determine whether it is suitable for transport and transmission to the current piece of remote equipment. For loop 1030 may be implemented as a “for” loop in many software languages.

For loop 1030 is an inner loop that is executed in the outer for loop 1010. This means that the server 112 loops through the entire list of Y mobile vehicles from 1 to Y for each piece of remote equipment in order from 1 to N.

In another example embodiment, for loop 1030 may be the outer loop and for loop 1010 may be the inner loop. Under such an arrangement, the server 112 loops through the entire list of N pieces of remote equipment from 1 to N for each mobile vehicle in the order from 1 to Y.

In for loop 1030, the server 112 executes analyze 1032, determine 1034, if likelihood 1036, and transfer 1038 for each mobile vehicle from 1 to Y for the current piece of remote equipment being assessed.

In analyze 1032, the server 112 accesses the records for the current mobile vehicle to analyze the past travel of the current mobile vehicle. Each mobile vehicle provides the server 112 with the record of each trip that it makes. The server 112 may analyze each trip to find patterns. The server 112 may analyze each trip with respect to the geographic location of the current piece of remote equipment.

Determine 1034 uses the patterns identified in analyze 1032 to determine a likelihood that the current mobile vehicle will drive past the geographic location of the current piece of remote equipment being considered. The likelihood may be expressed as a probability (e.g., 0-1). The likelihood may include a timeframe (e.g., within the next week, within the next month).

In if likelihood 1036, the likelihood that the mobile vehicle will drive past the geographic location of the current piece of remote equipment under consideration is compared to a threshold. The threshold may be any value in the range of 0-1. For example, an example embodiment, the threshold is 0.5 (e.g., 50% likelihood). In another example embodiment, the threshold is 0.7 (e.g., 70% likelihood).

If the likelihood determined in determine 1034 is greater than the threshold, then the server 112 executes transfer 1038. Otherwise, transfer 1038 is not executed for the current mobile vehicle. In other words, if the likelihood is greater than the threshold, the data for the current piece of remote equipment is transferred to the mobile vehicle. If the likelihood is less than or equal to the threshold, the data for the current piece of remote equipment is not transferred to the mobile vehicle.

In transfer 1038, the data that is available for transmission to the current piece of remote equipment is transferred to the current mobile vehicle being analyzed. The example method 700 of FIG. 7 may be used to transfer the data to the mobile vehicle.

The example method 1100 includes for loop 1010, if available 1020, for loop 1130, analyze 1132, if travel 1134, and transfer 1038.

For loop 1010 is discussed above.

If available 1020 is discussed above.

For loop 1130 is the same as for loop 1030 except that in for loop 1130, the server 112 executes analyze 1132, if travel 1134 in place of analyze 1032, determine 1034 and if likelihood 1036.

In analyze 1132, the server 112 accesses the records for the current mobile vehicle (e.g., 170-180) to analyze the future intended travel plans of the current mobile vehicle. The server 112 may analyze the future intended travel plans of the current mobile vehicle with respect to the geographic location of the current piece of remote equipment (e.g., 120-126, 132, 134, 152). Analyze 1132 determines whether the current mobile vehicle will be traveling past the current piece of remote equipment at some time in the future. The server 112 may use a time limit (e.g., day, week, month) in determining whether the current mobile vehicle is going past the current remote equipment. For example, the server 112 may require that the future travel plans take the current mobile vehicle past current remote equipment within the next 10 days.

In if travel 1134, the results from analyze 1132 is used to determine if the current mobile vehicle will travel past the current piece of remote equipment. If the current mobile vehicle will travel past the current piece of remote equipment, then the server 112 executes transfer 1038. Otherwise, transfer 1038 is not executed for the current mobile vehicle. In other words, if the mobile vehicle will travel past the current piece of remote equipment, the data intended for the current piece of remote equipment is transferred to the mobile vehicle. If the mobile vehicle will not travel past the current piece of remote equipment, the data for the current piece of remote equipment is not transferred to the mobile vehicle.

Transfer 738 is discussed above.

### Example Embodiments of a System for Transferring Data

Above, the transfer of data between the server 112 and the remote equipment 120-126, 132, 134 and 152 was discussed in terms of transfer from the server 112 to the mobile vehicle 170-180 (e.g., method 700) and from the mobile vehicle 170-182 the remote equipment (e.g., method 800). The example methods 900, 1500 and 1600 discussed the transfer data from remote equipment to the server in terms of transfers from the remote equipment to the mobile vehicle 170-180 to the server 112. Below the transfer of data between the server 112 and the remote equipment is discussed as a system that includes the server 112, the mobile vehicles 170-180 and the remote equipment 120-126, 132, 134 and 152 That by directionally transfers data between the server 112 and the remote equipment. The system discussed below is supported by the combination of example methods 700, 800, 900, 1500 and 1600.

A system for transferring data (e.g., physical transport and subsequent transmission) between the server 112 and remote equipment (e.g., 120-126, 132, 134, 152) includes a mobile vehicle (e.g., 170-180), the remote equipment, the server 112 and the long-range network 220. The transfer between the server 112 to the remote equipment takes place between a first location and a remote location. In these example embodiments, the mobile vehicle may be any one of the mobile vehicles 170-180 and the remote equipment may be any one of the charging station 120-126 or the machines 132, 134 or 152.

The mobile vehicle includes a first computer 250. The first computer 250 includes a first memory 1830. The first computer 250 is attached to the mobile vehicle whereby the mobile vehicle carries the first computer 250 and thereby the first and the second data stored in the first memory 1830 with it as it travels. The mobile vehicle is adapted to travel between the first location and the remote location. The mobile vehicle may travel between the first location and the remote location using any route and during any timeframe. The driver of the mobile vehicle may control the route and the timeframe of travel.

The remote equipment includes a second computer (e.g., 330, 450). The second computer is attached to the remote equipment. The remote equipment is positioned at the remote location on a long-term basis. In other words, the remote equipment remains at the remote location. The remote equipment is not mobile like a mobile vehicle.

The server 112 is adapted to store the first and the second data. The first and the second data may be data for transfer to the remote equipment or data received from the remote equipment while the remote equipment is positioned at the remote location.

The long-range network 220 is adapted to communicate with the server 112. While the mobile vehicle is positioned at the first location, the first computer 250 is adapted to communicate with the long-range network 220 and the server 112. While the mobile vehicle and the remote equipment are positioned at the remote location, the first computer 250 and the second computer (e.g., 330, 450) respectively cannot communicate with the long-range network 220 or the server 112. While the mobile vehicle and the remote equipment are positioned at the remote location, the first computer and the second computer are out of range of the long-range network 220 and therefore cannot communicate with the server 112.

While the mobile vehicle is positioned at the first location, the first computer 250 is adapted to communicate with the server 112 via the long-range network 220 to receive a first data from the server 112. The first data intended for transfer to the remote equipment. The first data stored in the first memory 1830. As the mobile vehicle travels from the first location to the remote location, the mobile vehicle is configured to physically transport the first computer 250 and thereby the first data from the first location to the remote location. While the mobile vehicle is positioned at the remote location, the first computer 250 is adapted to transmit the first data to the remote equipment via a short-range wireless communication link (e.g., 410, 414) thereby completing physically transporting and subsequently transmitting the first data from the server 112 to the remote equipment.

While the mobile vehicle is positioned at the remote location, the first computer 250 is also adapted to receive the second data from the remote equipment via the short-range wireless communication link (e.g., 410, 414). The second data intended for transfer to the server 112. The second data is stored in the first memory 1830. As the mobile vehicle travels from the remote location to the first location, the mobile vehicle is configured to physically transport the first computer 250 and thereby the second data from the remote location to the first location. While the mobile vehicle is positioned at the first location, the first computer 250 is adapted to communicate with the server 112 via the long-range network 220 to transmit the second data to the server 112 thereby completing physically transporting and subsequently transmitting the second data from the remote equipment to the server.

In an example embodiment, the first data includes an identifier that identifies the remote equipment as the intended recipient of the first data. The second data includes an identifier that identifies the server 112 as the intended recipient of the second data. The driver of the mobile vehicle controls the timing and the route of travel between the first location and the remote location in both directions. The server, the mobile vehicle, the remote equipment or any other entity does not specify the timing or the route of travel between the first location and the remote location. While the mobile vehicle is positioned at the first location, the first computer 250 is adapted to communicate with the long-range network 220 via a second short-range wireless communication link (e.g., 210).

### INCORPORATION BY REFERENCE

Examples of a server receiving financial transaction data from a charging station are provided in U.S. provisional patent application No. 63/178,495, filed Apr. 22, 2021 and entitled “Methods and Apparatus for Data Transport and Transmission from a Remote Location”, which is incorporated herein by reference in its entirety.

Examples of a server receiving health data from a charging station and/or a machine are provided in U.S. provisional patent application No. 63/180,684, filed Apr. 28, 2021 and entitled “Methods and Apparatus for Transport and Transmission of Health and Operational Data from a Remote Location”, which is incorporated herein by reference in its entirety.

Examples of a server sending data to a charging station and/or a machine are provided in U.S. provisional patent application No. 63/182,870, filed May 1, 2021 and entitled “Methods and Apparatus for Transport and Transmission of Data to a Remote Location”, which is incorporated herein by reference in its entirety.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for physically transporting and subsequently transmitting a first and a second data, the system comprising:
a mobile vehicle, the mobile vehicle includes a first computer, the first computer includes a first memory, the first computer is attached to the mobile vehicle whereby the mobile vehicle carries the first computer and thereby the first and the second data stored in the first memory with it as it travels, the mobile vehicle adapted to travel between a first location and a remote location;
a remote equipment, the remote equipment includes a second computer, the second computer, is attached to the remote equipment, the remote equipment is positioned at the remote location on a long-term basis;
a server adapted to store the first and the second data for least one of transfer to and receipt from the remote equipment while the remote equipment is positioned at the remote location;
a long-range network, the long-range network adapted to communicate with the server, while the mobile vehicle is positioned at the first location, the first computer is adapted to communicate with the long-range network and the server, while the mobile vehicle and the remote equipment are positioned at the remote location, the first computer and the second computer respectively cannot communicate with the long-range network or the server; wherein:
while the mobile vehicle is positioned at the first location, the first computer is adapted to communicate with the server via the long-range network to receive a first data from the server, the first data intended for transfer to the remote equipment, the first data stored at the first memory;
as the mobile vehicle travels from the first location to the remote location, the mobile vehicle is configured to physically transport the first computer and thereby the first data from the first location to the remote location;
while the mobile vehicle is positioned at the remote location, the first computer is adapted to transmit the first data to the remote equipment via a short-range wireless communication link thereby completing physically transporting and subsequently transmitting the first data from the server to the remote equipment;
while the mobile vehicle is positioned at the remote location, the first computer is adapted to receive a second data from the remote equipment via the short-range wireless communication link, the second data intended for transfer to the server, the second data stored in the first memory;
as the mobile vehicle travels from the remote location to the first location, the mobile vehicle is configured to physically transport the first computer and thereby the second data from the remote location to the first location; and
while the mobile vehicle is positioned at the first location, the first computer is adapted to communicate with the server via the long-range network to transmit the second data to the server thereby completing physically transporting and subsequently transmitting the second data from the remote equipment to the server.

2. The system of claim 1 wherein the remote equipment comprises a charging station.

3. The system of claim 1 wherein the remote equipment comprises an electric machine.

4. The system of claim 1 wherein a driver of the mobile vehicle controls a timing and a route of travel between the first location and the remote location.

5. The system of claim 1 wherein the server does not specify a timing or a route of travel between the first location and the remote location.

6. The system of claim 1 wherein the remote equipment does not specify a timing or a route of travel between the first location and the remote location.

7. The system of claim 1 wherein the mobile vehicle comprises an electric vehicle.

8. The system of claim 1 wherein the remote equipment comprises an electric equipment.

9. The system of claim 1 wherein while the mobile vehicle is positioned at the first location, the first computer is adapted to communicate with the long-range network via a second short-range wireless communication link.

10. A system for physically transporting and subsequently transmitting a first data, the system comprising:
a mobile vehicle, the mobile vehicle includes a first computer, the first computer includes a first memory, the first computer is attached to the mobile vehicle whereby the mobile vehicle carries the first computer and thereby the first data stored in the first memory with it as it travels, the mobile vehicle adapted to travel between a first location and a remote location;
a remote equipment, the remote equipment includes a second computer, the second computer, is attached to the remote equipment, the remote equipment is positioned at the remote location on a long-term basis;
a server adapted to store the first data for least one of transfer to and receipt from the remote equipment while the remote equipment is positioned at the remote location;
a long-range network, the long-range network adapted to communicate with the server, while the mobile vehicle is positioned at the first location, the first computer is adapted to communicate with the long-range network and the server, while the mobile vehicle and the remote equipment are positioned at the remote location, the first computer and the second computer respectively cannot communicate with the long-range network or the server; wherein:
while the mobile vehicle is positioned at the first location, the first computer is adapted to communicate with the server via the long-range network to receive a first data from the server, the first data intended for transfer to the remote equipment, the first data stored at the first memory;
as the mobile vehicle travels from the first location to the remote location, the mobile vehicle is configured to physically transport the first computer and thereby the first data from the first location to the remote location; and
while the mobile vehicle is positioned at the remote location, the first computer is adapted to transmit the first data to the remote equipment via a short-range wireless communication link thereby completing physically transporting and subsequently transmitting the first data from the server to the remote equipment.

11. The system of claim 10 wherein a driver of the mobile vehicle controls a timing and a route of travel between the remote location and the first location.

12. The system of claim 10 wherein the remote equipment comprises a charging station.

13. The system of claim 10 wherein the remote equipment comprises an electric machine.

14. The system of claim 10 wherein the server does not specify a timing or a route of travel between the first location and the remote location.

15. The system of claim 10 wherein the mobile vehicle comprises an electric vehicle.

16. A system for physically transporting and subsequently transmitting a second data, the system comprising:
a mobile vehicle, the mobile vehicle includes a first computer, the first computer includes a first memory, the first computer is attached to the mobile vehicle whereby the mobile vehicle carries the first computer and thereby the second data stored in the first memory with it as it travels, the mobile vehicle adapted to travel between a first location and a remote location;
a remote equipment, the remote equipment includes a second computer, the second computer, is attached to the remote equipment, the remote equipment is positioned at the remote location on a long-term basis;
a server adapted to store second data for least one of transfer to and receipt from the remote equipment while the remote equipment is positioned at the remote location;
a long-range network, the long-range network adapted to communicate with the server, while the mobile vehicle is positioned at the first location, the first computer is adapted to communicate with the long-range network and the server, while the mobile vehicle and the remote equipment are positioned at the remote location, the first computer and the second computer respectively cannot communicate with the long-range network or the server; wherein:
while the mobile vehicle is positioned at the remote location, the first computer is adapted to receive a second data from the remote equipment via a short-range wireless communication link, the second data intended for transfer to the server, the second data stored in the first memory;
as the mobile vehicle travels from the remote location to the first location, the mobile vehicle is configured to physically transport the first computer and thereby the second data from the remote location to the first location; and
while the mobile vehicle is positioned at the first location, the first computer is adapted to communicate with the server via the long-range network to transmit the second data to the server thereby physically transporting and subsequently transmitting the second data from the remote equipment to the server.

17. The system of claim 16 wherein a driver of the mobile vehicle controls a timing and a route of travel between the remote location and the first location.

18. The system of claim 16 wherein the remote equipment comprises a charging station.

19. The system of claim 16 wherein the remote equipment comprises an electric machine.

20. The system of claim 16 wherein the remote equipment does not specify a timing or a route of travel between the remote location and the first location.
